(19) United States
(12) Patent Application Publication
(10) Pub. No.: US 2019/0168065 A1
(43) Pub. Date: Jun. 6, 2019

(54) ACTIVE STROLLER ENTERTAINMENT SYSTEM

(71) Applicant: Rose Brancatelli, Soquel, CA (US)

(72) Inventor: Rose Brancatelli, Soquel, CA (US)

(21) Appl. No.: 15/829,863

(22) Filed: Dec. 1, 2017

(51) Int. Cl. A63B 22/00; A47D 13/08; A47D 13/10; A63B 5/11; A63B 22/06; A63B 71/00; A63B 26/00; A63B 23/04; A63B 21/00; A63G 31/02; B62B 9/10

(52) U.S. Cl. CPC A63B 22/0046; A47D 13/08; A47D 13/107; A63B 5/11; A63B 22/0605; A63B 2022/0635; A63B 26/003; A63B 23/0476; A63B 21/0004; A63G 31/02; B62B 9/10; A63B 71/0054

(57) ABSTRACT

Disclosed apparatus include an active stroller entertainment system including an activity base system, attachable with a stroller chassis, to facilitate a physical activity for a child when the child is inside the stroller, and a protective support system configured to operatively couple with the activity base system to support the child during the physical activity. Embodiments include the activity base system and the protective support system detachably attached with a stroller chassis, at least in part to form an activity area, inside the stroller, sufficient to facilitate the physical activity when the child is inside the stroller, while operatively providing support to the child and protection from physical injury within the activity area during the physical activity. The activity area is configured by comprising equipment particularly related to the physical activity, with which the child can actively interact, to improve the child's physical activity skills.

### FIELD OF THE DISCLOSURE

This disclosure relates generally to the field of strollers and prams designed to carry children and/or babies. In particular, the disclosure relates to an active stroller entertainment system.

### BACKGROUND OF THE DISCLOSURE

Modern strollers are most typically used to carry babies and/or children of the ages from approximately six months to approximately five years in a sitting position. The market for comfort strollers in the United States is broadly driven by the improved features and designs of comfort strollers. For instance, some strollers come with a reversible seat feature. This allows a caregiver to seat the child either facing forward or facing backward toward the caregiver. Light weight, and the ease with which the stroller can be folded using a single arm are other features, which contribute to the popularity of comfort strollers.

Vendors that offer baby strollers and prams focus primarily on improving the technology and features integrated into their products to attract more consumers, especially in the United States. Manufacturers of baby stroller products are rigorously tested and certified by respective safety standard programs in the United States, such as the Juvenile Products Manufacturers Association (JPMA). Vendors ensure that their strollers are compliant with various standards so that they can project their products in the United States market as safe to use.

By some accounts, the global market for baby strollers in 2016 was approximately $460.16 million and is expected to grow at a Compound Annual Growth Rate (CAGR) of 5.92% to reach approximately $487.4 million in 2017 and approximately $649.74 million in 2022. Since much of the anticipated growth in the global market is expected to shift toward the lower-cost manufacturers, established vendors must increasingly focus on improved features and designs for their strollers to maintain market share and profit margins going forward.

To date, more options for the vendors that offer baby strollers and prams to maintain their market share and profit margins by offering improved designs and/or features have not been fully explored.

### BRIEF DESCRIPTION OF THE DRAWINGS

The present invention is illustrated by way of example and not limitation in the figures of the accompanying drawings.

FIG. 1A illustrates one embodiment of a stroller chassis coupled with an activity area in an active stroller entertainment system.

FIG. 1B illustrates one embodiment of an activity configuration comprised of an activity base system in an activity area for an active stroller entertainment system, for example, such as active stroller entertainment system.

FIG. 1C illustrates one alternative embodiment of an activity configuration comprised of an activity base system and a protective support system in an activity area for an active stroller entertainment system.

FIG. 2A illustrates one embodiment of an activity configuration comprised of an activity base system in an activity area for an active stroller entertainment system.

FIG. 2B illustrates one embodiment of a stroller chassis coupled with an activity area comprising an activity base system in an active stroller entertainment system.

FIG. 3A illustrates one alternative embodiment of an activity configuration comprised of an activity base system in an activity area for an active stroller entertainment system.

FIG. 3B illustrates one alternative embodiment of a stroller chassis coupled with an activity area comprising an activity base system in an active stroller entertainment system.

FIG. 3C illustrates an alternative embodiment of an activity configuration comprised of an activity base system operatively coupled with a protective support system in an activity area for an active stroller entertainment system.

FIG. 3D illustrates another alternative embodiment of an activity configuration comprised of an activity base system in an activity area for an active stroller entertainment system.

FIG. 4A illustrates another alternative embodiment of an activity configuration comprised of an activity base system in an activity area for an active stroller entertainment system.

FIG. 4B illustrates another alternative embodiment of a stroller chassis coupled with an activity area comprising an activity base system in an active stroller entertainment system.

FIG. 5 illustrates an alternative embodiment of a stroller chassis coupled with an activity base system in an activity area of an active stroller entertainment system.

FIG. 6A illustrates another alternative embodiment of an activity configuration comprised of an activity base system in an activity area for an active stroller entertainment system.

FIG. 6B illustrates another alternative embodiment of a stroller chassis coupled with an activity area comprising an activity base system in an active stroller entertainment system.

FIG. 6C illustrates one embodiment of a stroller chassis coupled with a protective support system in an activity area of an active stroller entertainment system.

FIG. 6D illustrates one alternative embodiment of a stroller chassis coupled with a protective support system in an activity area of an active stroller entertainment system.

FIG. 6E illustrates an alternative embodiment of an activity configuration comprised of an activity base system operatively coupled with a protective support system in an activity area for an active stroller entertainment system.

FIG. 6F illustrates another alternative embodiment of an activity configuration comprised of an activity base system operatively coupled with a protective support system in an activity area for an active stroller entertainment system.

FIG. 7A illustrates another alternative embodiment of an activity configuration comprised of an activity base system in an activity area for an active stroller entertainment system.

FIG. 7B illustrates another alternative embodiment of a stroller chassis coupled with an activity area comprising an activity base system in an active stroller entertainment system.

FIG. 7C illustrates another alternative embodiment of an activity configuration comprised of an activity base system in an activity area for an active stroller entertainment system.

FIG. 8A illustrates another alternative embodiment of an activity configuration comprised of an activity base system in an activity area for an active stroller entertainment system.

FIG. 8B illustrates one alternative embodiment of a stroller chassis extendedly coupled with an activity area in an active stroller entertainment system.

FIG. 8C illustrates an alternative embodiment of an extended stroller chassis coupled with an activity area comprising an activity base system in an active stroller entertainment system.

FIG. 9A illustrates another alternative embodiment of an activity configuration comprised of an activity base system in an activity area for an active stroller entertainment system.

FIG. 9B illustrates an alternative embodiment of a stroller chassis coupled with an activity area in an active stroller entertainment system.

FIG. 9C illustrates an alternative embodiment of a stroller chassis coupled with an activity area comprising an activity base system in an active stroller entertainment system.

FIG. 9D illustrates another alternative embodiment of a stroller chassis coupled with an activity area in an active stroller entertainment system.

FIG. 9E illustrates another alternative embodiment of a stroller chassis coupled with an activity area comprising an activity base system in an active stroller entertainment system.

FIG. 10A illustrates another alternative embodiment of an activity configuration comprised of an activity base system in an activity area for an active stroller entertainment system.

FIG. 10B illustrates another alternative embodiment of a stroller chassis coupled with an activity area comprising an activity base system and operatively coupled with a protective support system in an active stroller entertainment system.

FIG. 11A illustrates another alternative embodiment of an activity configuration comprised of an activity base system in an activity area for an active stroller entertainment system.

FIG. 11B illustrates another alternative embodiment of a stroller chassis coupled with an activity area comprising an activity base system in an active stroller entertainment system.

FIG. 12A illustrates another alternative embodiment of an activity configuration comprised of an activity base system in an activity area for an active stroller entertainment system.

FIG. 12B illustrates an alternative embodiment of a stroller chassis coupled with an activity area in an active stroller entertainment system.

FIG. 12C illustrates an alternative embodiment of a stroller chassis coupled with an activity area comprising an activity base system in an active stroller entertainment system.

FIG. 13A illustrates another alternative embodiment of an activity configuration comprised of an activity base system in an activity area for an active stroller entertainment system.

FIG. 13B illustrates another alternative embodiment of a stroller chassis coupled with an activity area comprising an activity base system in an active stroller entertainment system.

FIG. 13C illustrates another alternative embodiment of an activity configuration comprised of an activity base system in an activity area for an active stroller entertainment system.

FIG. 13D illustrates another alternative embodiment of an activity configuration comprised of an activity base system in an activity area for an active stroller entertainment system.

### DETAILED DESCRIPTION

Disclosed herein are apparatus and systems including an active stroller entertainment system including an activity base system, attachable with a stroller chassis, to facilitate a physical activity for a child when the child is inside the stroller, and a protective support system configured to operatively couple with the activity base system to support the child during the physical activity. Embodiments also include the activity base system and the protective support system detachably attached with a stroller chassis, at least in part to form an activity area, inside the stroller, of sufficient area to facilitate the physical activity when the child is inside the stroller, while operatively providing support to the child and protection from physical injury within the activity area during the physical activity. These activity areas may be configured by comprising equipment particularly related to each of the physical activities, with which the child can actively interact, to improve the child's physical activity skills. Embodiments of such physical activities may include but are not limited to: bouncing activities, e.g. such as a bouncer seat or harness, a bounce ball, or a trampoline; climbing activities, e.g. such as rock climbing, or rope climbing; balancing activities, e.g. such as skateboarding, snow boarding, surfing, a strider/trainer bike, a scooter, or a skiing simulator; pedaling activities, e.g. such as pedal pushing wheel walkers, a tricycle, a bicycle, a pedal go-kart; or drifting activities, e.g. such as an EzyRoller™ or EzyRoller™ Junior (trademarks of EzyRoller Ltd).

Thus, such physical activities may be facilitated by these apparatus and systems through an active stroller entertainment system including an activity base system, attachable with a stroller chassis to provide an entertaining activity for a child when the child is inside the stroller, and a protective support system configured to operatively couple with the activity base system to support the child during the physical activity.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than a restrictive sense and the invention measured only in terms of the claims and their equivalents.

One embodiment replaces the various child-carrying configurations of a traditional comfort stroller with an active stroller entertainment system including an activity base system, attachable with the stroller chassis. The active stroller entertainment system provides a protective environment where the child may play in anticipation of various physical activities, while safely developing and improving skills, e.g. such as strength, balance, coordination, etc., which are necessary to the child's successful participation in such activities. The active stroller entertainment system also provides a secure system for transporting the child along with any equipment required for such physical activities through city streets and traffic, to the playground area, event center, or park where such physical activities may be safely pursued.

It will be appreciated that in the following figures, illustrations of example embodiments of active stroller entertainment systems and component systems thereof are presented. Similar or identical illustrated features may be assigned the same corresponding identifiers. For the purpose of explanation and not limitation, specific details are set forth below in order to provide a thorough understanding of various embodiments of the invention. However, it will be apparent to one skilled in the art that, without departing from the spirit of the claimed invention, other embodiments may be practiced that depart from some of the specific details depicted below. In other instances, detailed descriptions of well-known apparatus, hardware, etc., may be omitted so not to obscure the description of the invention with unnecessary detail.

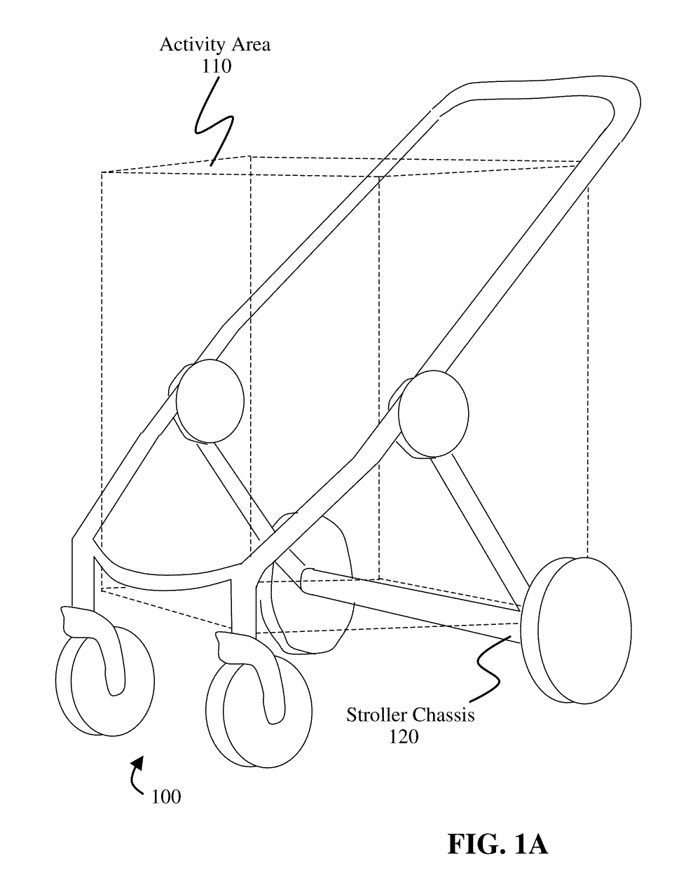

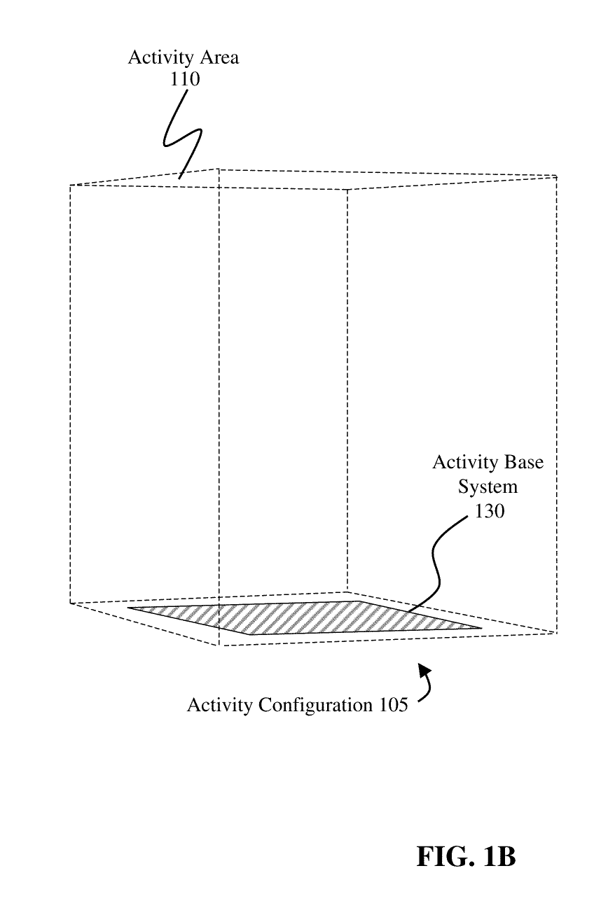

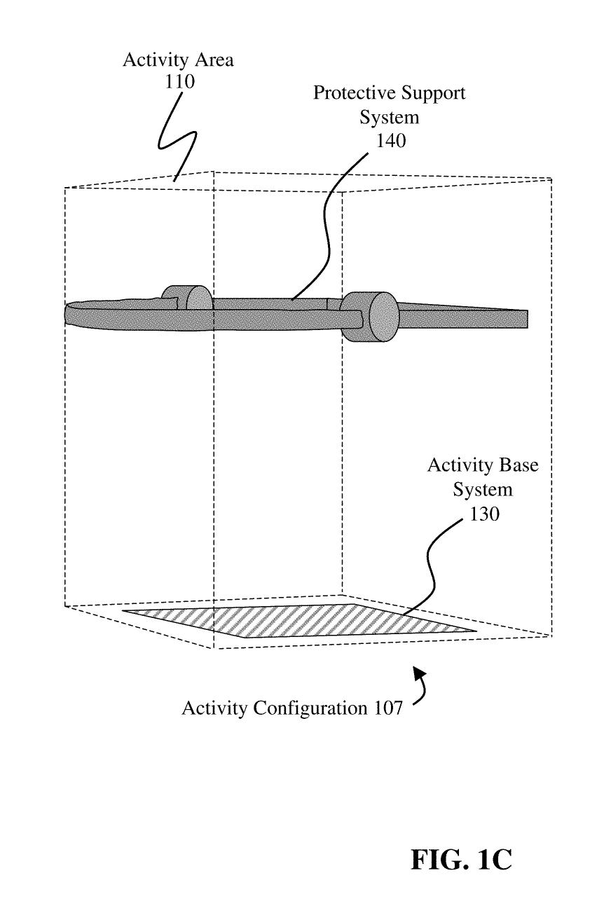

For example beginning with FIGS. 1A through 1C, embodiments of an active stroller entertainment system, may be seen in the abstract as including an activity base system, attachable with a stroller chassis, to facilitate a physical activity for a child, and optionally a protective support system configured to operatively couple with the activity base system to support the child during the physical activity if necessary. Certain embodiments may be seen in the abstract as including the activity base system and the protective support system as an activity configuration, which is detachably attachable with a stroller chassis, at least in part to form an activity area to facilitate the physical activity when the child is inside the stroller, while operatively providing support to the child and protection from physical injury within the activity area during the physical activity. In some embodiments, portions of the activity configuration may be detached from the stroller chassis and still provide apparatus and/or equipment to facilitate a physical activity when the child is not inside the stroller.

FIG. 1A illustrates, for example, one embodiment of a stroller chassis 120 coupled with an activity area 110 in an active stroller entertainment system 100 to facilitate a physical activity when the child is inside the stroller.

FIG. 1B illustrates one embodiment of an activity configuration 105 comprised of an activity base system 130, in an activity area 110 for an active stroller entertainment system, for example, such as active stroller entertainment system 100. In some embodiments, portions of the activity configuration 105 may be detached from the stroller chassis and still provide apparatus and/or equipment to facilitate a physical activity outside the stroller.

FIG. 1C illustrates one alternative embodiment of an activity configuration 107 comprised of an activity base system 130 and a protective support system 140 in activity area 110 for an active stroller entertainment system, for example, such as active stroller entertainment system 100. Likewise in some embodiments, portions of the activity configuration 107 may be detached from the stroller chassis and still provide apparatus and/or equipment to facilitate a physical activity outside the stroller.

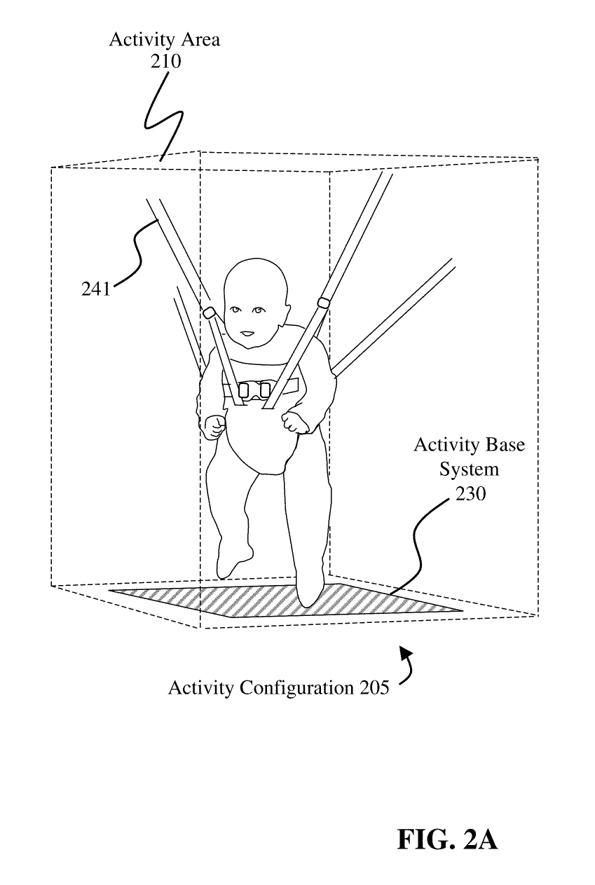

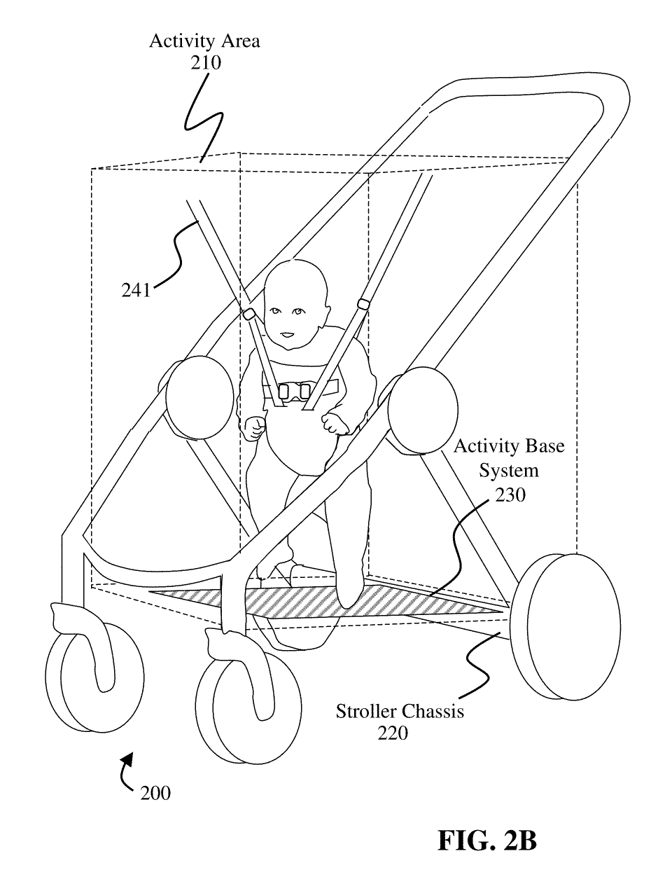

FIG. 2A illustrates one specific embodiment of an activity configuration 205 comprised of an activity base system 230 and a protective support system 241 for a bouncing activity in an activity area 210 for an active stroller entertainment system. Some embodiments of activity configuration 205 may comprise a protective support system 241 including nylon or another type of strapping, or bouncy elastic bungee cords, or some combination of both—operatively providing support to the child and protection from physical injury within the activity area during the physical activity.

In some embodiments of activity configuration 205, activity base system 230 may comprise a bouncy surface, e.g. such as rubber, inflatable, or trampoline; or alternatively may comprise a firm surface, e.g. such as a formed foam or plastic floor; and wherein either embodiments may comprise surfaces with enhanced traction to prevent a child from slipping. Some embodiments of the protective support system 241 may also include a baby pouch or sling carrier, which could also be useful for carrying the baby, when the baby is outside of the stroller.

FIG. 2B illustrates one embodiment of a stroller chassis 220 coupled with activity area 210 comprising activity base system 230 and a protective support system 241 for a bouncing activity in active stroller entertainment system 200.

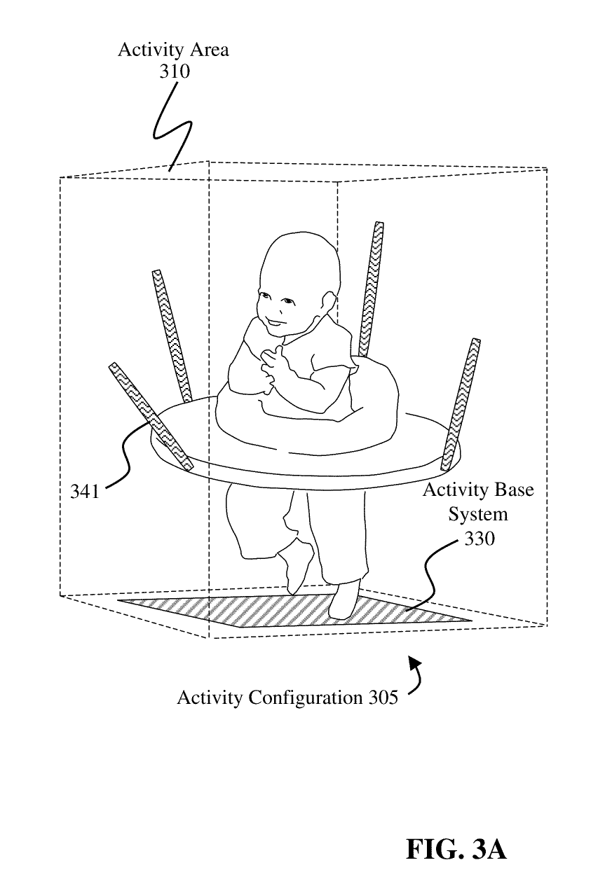

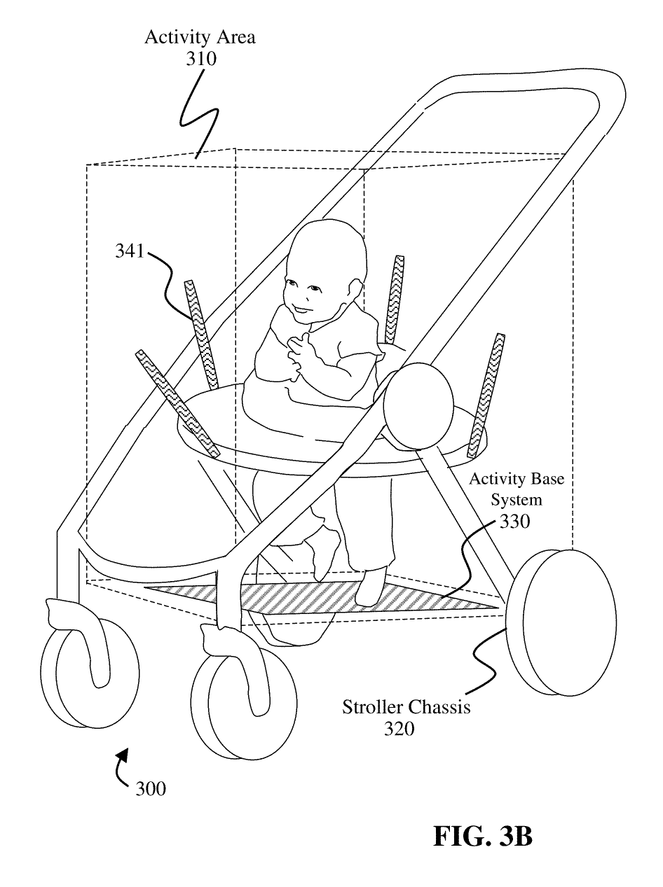

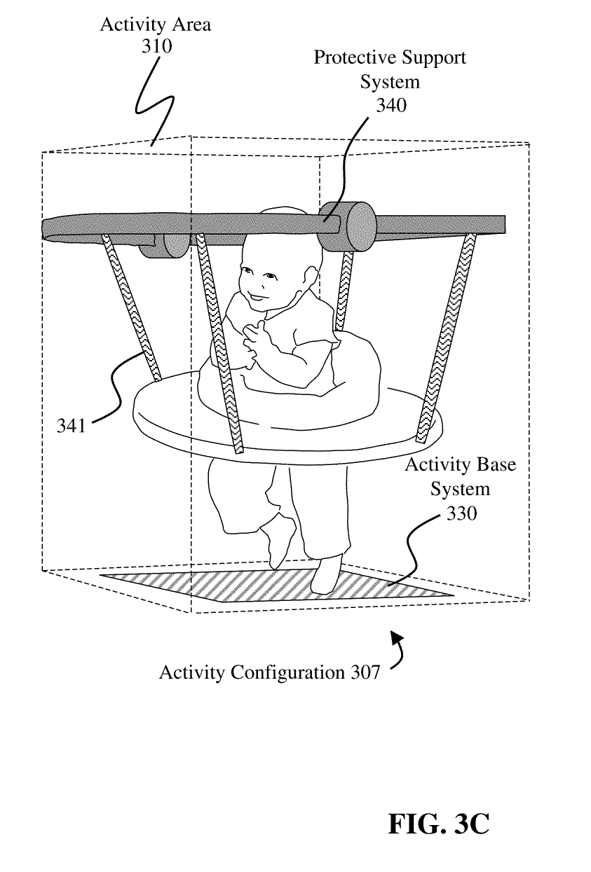

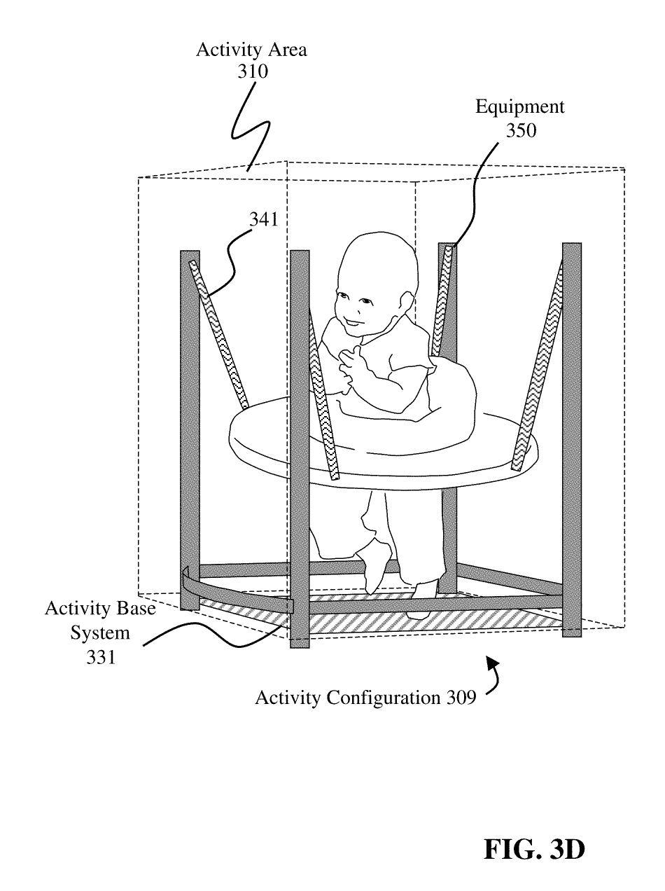

FIG. 3A illustrates one alternative embodiment of an activity configuration 305 comprised of an activity base system 330 and a protective support system 341 for a bouncing activity in an activity area 310 for an active stroller entertainment system. Similarly, embodiments of activity configuration 305 may comprise a protective support system 341 including nylon or another type of strapping, or bouncy elastic bungee cords, or some combination of both.

In some embodiments of activity configuration 305, activity base system 330 may comprise a bouncy surface, e.g. such as rubber, inflatable, or trampoline; or alternatively may comprise a firm surface, e.g. such as a formed foam or plastic floor; and wherein either embodiments may comprise surfaces with enhanced traction to prevent a child from slipping. Some embodiments of the protective support system 341 may also include a child bouncer or jumper seat and tray, which could also be useful to facilitate the bouncing activity, when the baby is outside of the stroller.

FIG. 3B illustrates one alternative embodiment of a stroller chassis 320 coupled with activity area 310 comprising activity base system 330 and a protective support system 341 for a bouncing activity in active stroller entertainment system 300.

FIG. 3C illustrates an alternative embodiment of an activity configuration 307 comprised of an activity base system 330 and protective support system(s) 340 and 341 for a bouncing activity in an activity area 310 for an active stroller entertainment system, for example, such as active stroller entertainment system 300.

FIG. 3D illustrates another alternative embodiment of an activity configuration 309 comprised of an activity base system 331 and protective support system 341 for a bouncing activity in an activity area 310 for an active stroller entertainment system, for example, such as active stroller entertainment system 300. In some embodiments, portions of activity configuration 309 may be detached from the stroller chassis and still provide apparatus and/or equipment 350 to facilitate the bouncing activity outside the stroller. It will be appreciated that in some embodiments the protective support system 341 may also comprise a portion of the detachable apparatus and/or equipment 350 to facilitate bouncing activity outside the stroller.

In some embodiments of activity configuration 309, activity base system 331 may comprise a bouncy surface, e.g. such as rubber, inflatable, or trampoline; or alternatively may comprise a firm surface, e.g. such as a formed foam or plastic floor; and wherein either embodiments may comprise surfaces with enhanced traction to prevent a child from slipping, and/or easily cleanable surfaces or washable fabrics, e.g. to provide for cleaning up spills etc.

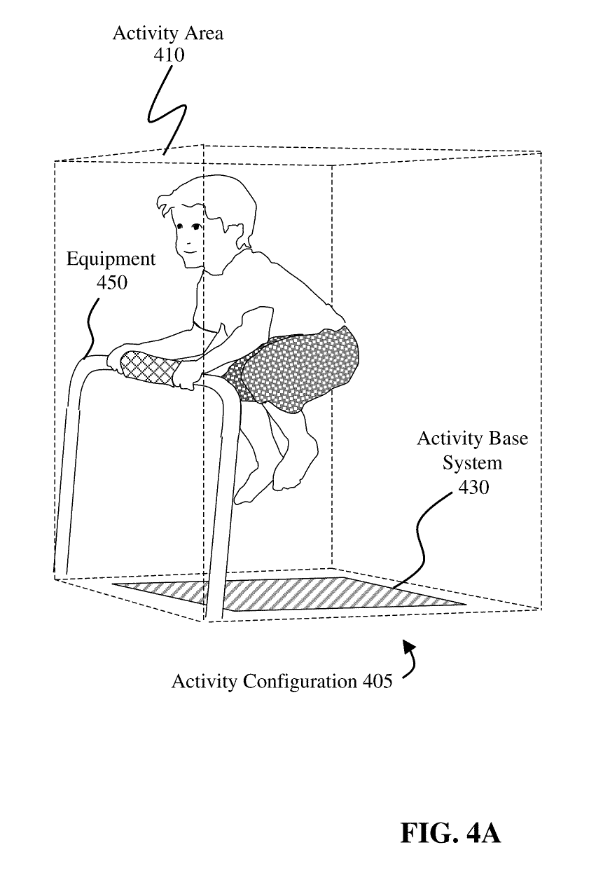

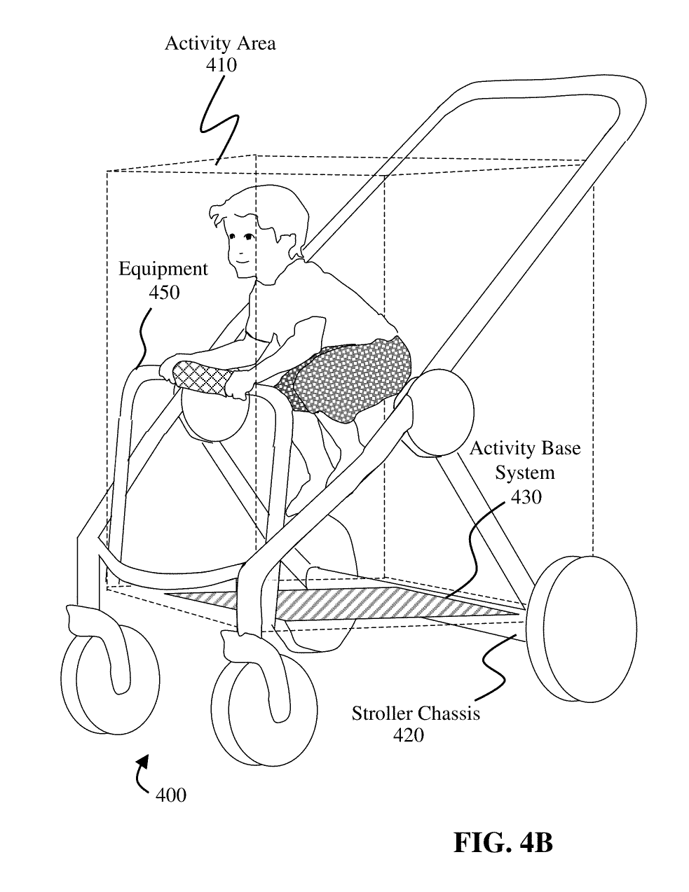

FIG. 4A illustrates another alternative embodiment of an activity configuration 405 comprised of an activity base system 430 for a bouncing activity in an activity area 410 for an active stroller entertainment system. In some embodiments, portions of activity configuration 405 may be detached from the stroller chassis and still provide apparatus and/or equipment 450 to facilitate the bouncing activity outside the stroller. It will be appreciated that in some embodiments the activity base system 430 may also comprise a portion of the detachable apparatus and/or equipment 450 to facilitate bouncing activity outside the stroller.

In some embodiments of activity configuration 405, activity base system 430 may comprise a bouncy surface, e.g. such as rubber, inflatable, or trampoline; and may also comprise surfaces with enhanced traction to prevent a child from slipping, and/or easily cleanable surfaces or washable fabrics, e.g. to provide for easier clean ups.

FIG. 4B illustrates another alternative embodiment of a stroller chassis 420 coupled with activity area 410 comprising activity base system 430 for a bouncing activity in active stroller entertainment system 400.

It will be appreciated that in some cases, a child's physical activity, may be sufficiently energetic to cause disruptions in the normal operation of a light-weight stroller. In some embodiments a stroller chassis may be configured accordingly, to help compensate for a child's physical activity when the child is inside the stroller.

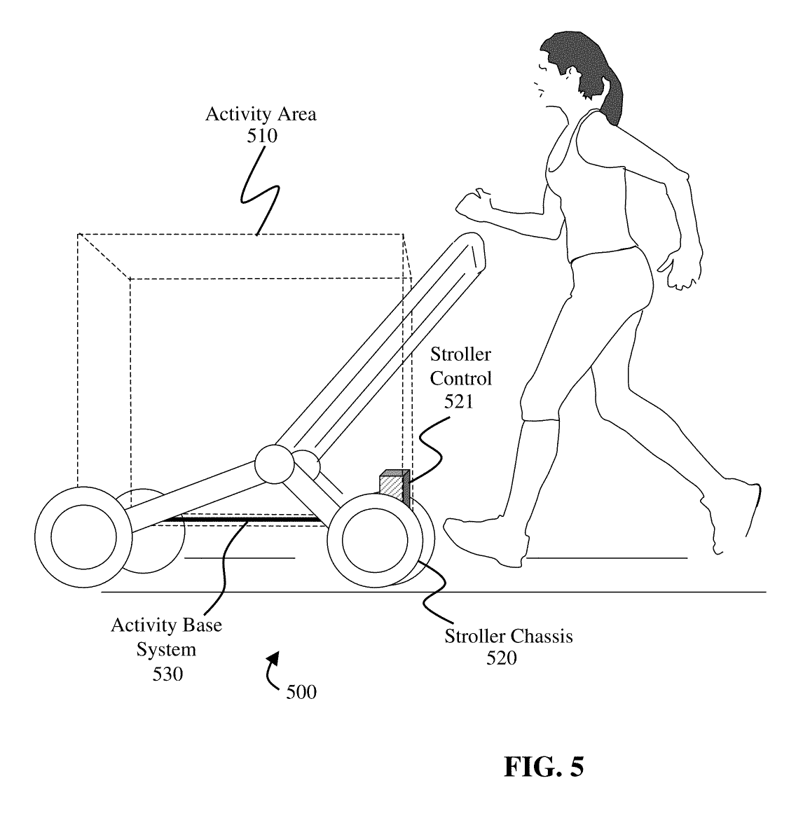

FIG. 5 illustrates an alternative embodiment of a stroller chassis 520 coupled with a stroller control 521 and an activity base system 530 in an activity area 510 of an active stroller entertainment system 500. In some embodiments of active stroller entertainment system 500, stroller control 521 comprises artificial intelligence capable of acquiring and remembering a predetermined path, and then independently propelling and driving the stroller along the predetermined path. In some embodiments of active stroller entertainment system 500, since the stroller control 521 is capable of independently propelling and driving the stroller, the stroller may be made heavier (e.g. using fluid filled tractor wheels and heavier framing) for greater stability and/or may incorporate intelligence to help compensate for a child's physical activity when the child is inside the stroller. In some embodiments the stroller control 521 may be capable of interacting, e.g. through sensors and/or the Internet of Things (IoT), with the activity base system 530 and components of the activity area 510 to dampen and/or to enhance the effects of a child's physical activity when the child is inside the stroller, e.g. dependent upon the location and movements of the stroller.

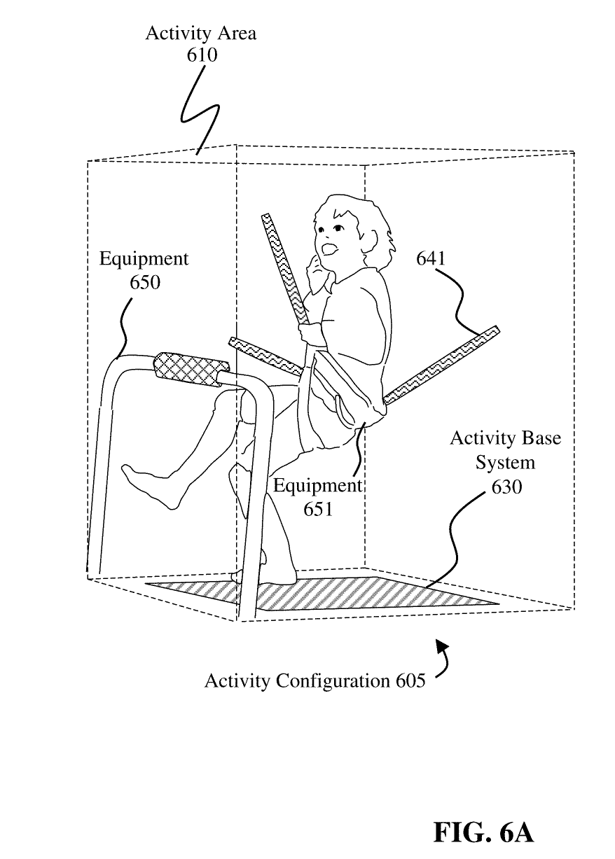

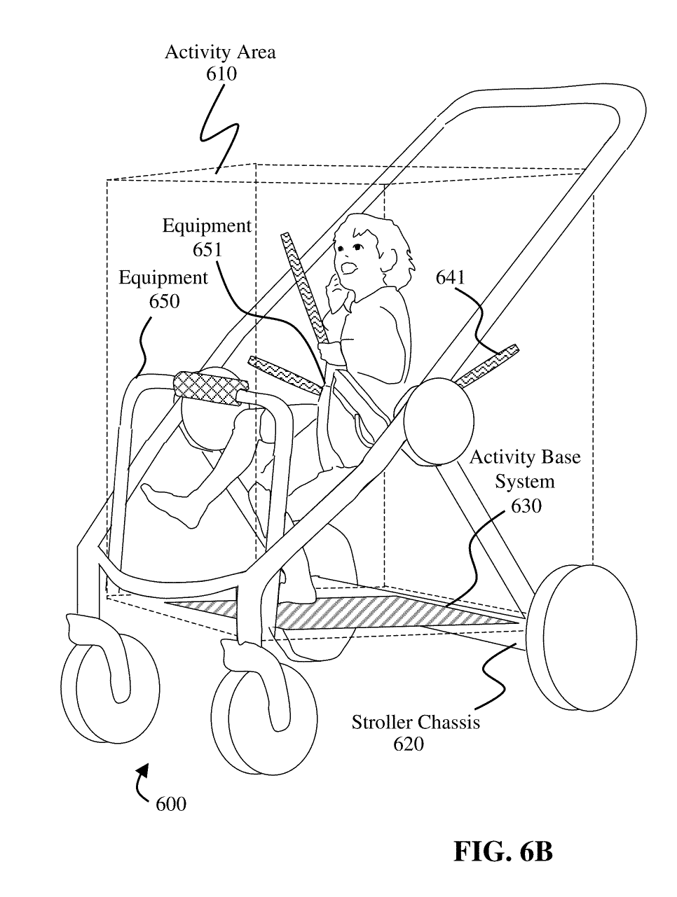

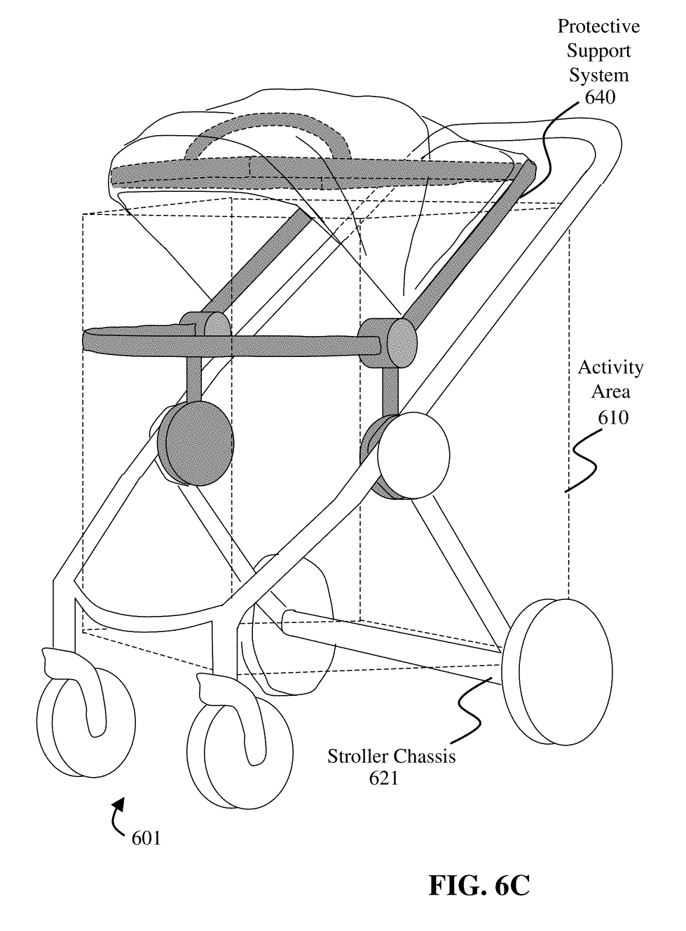

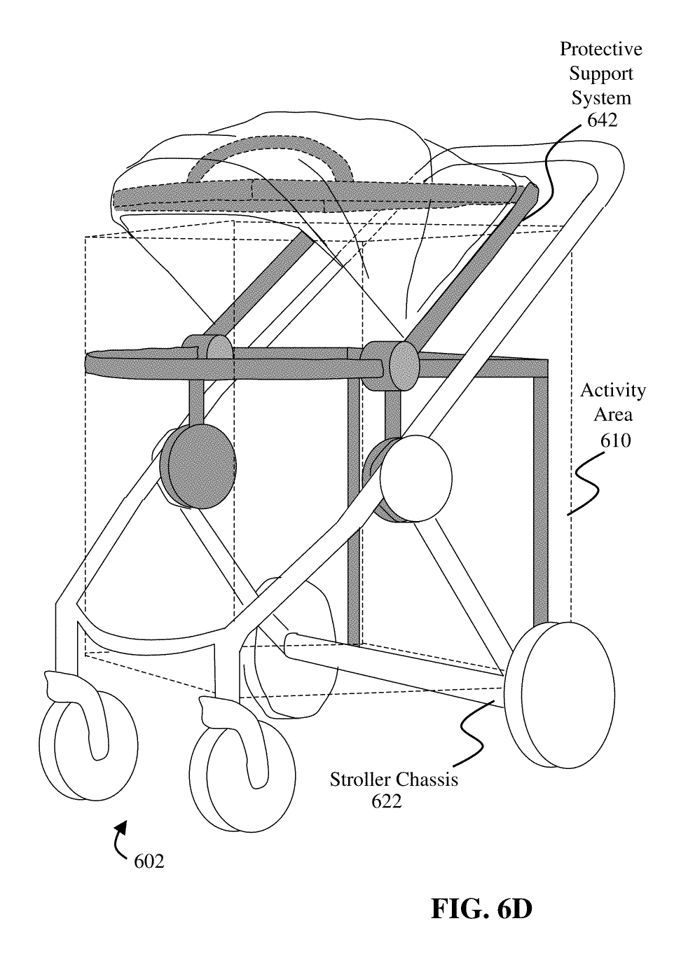

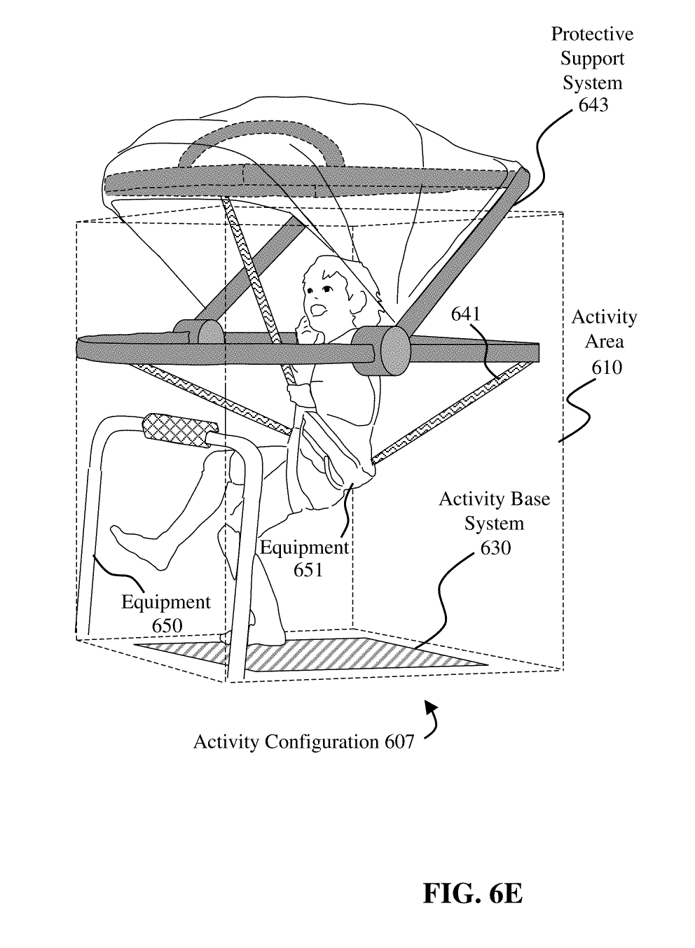

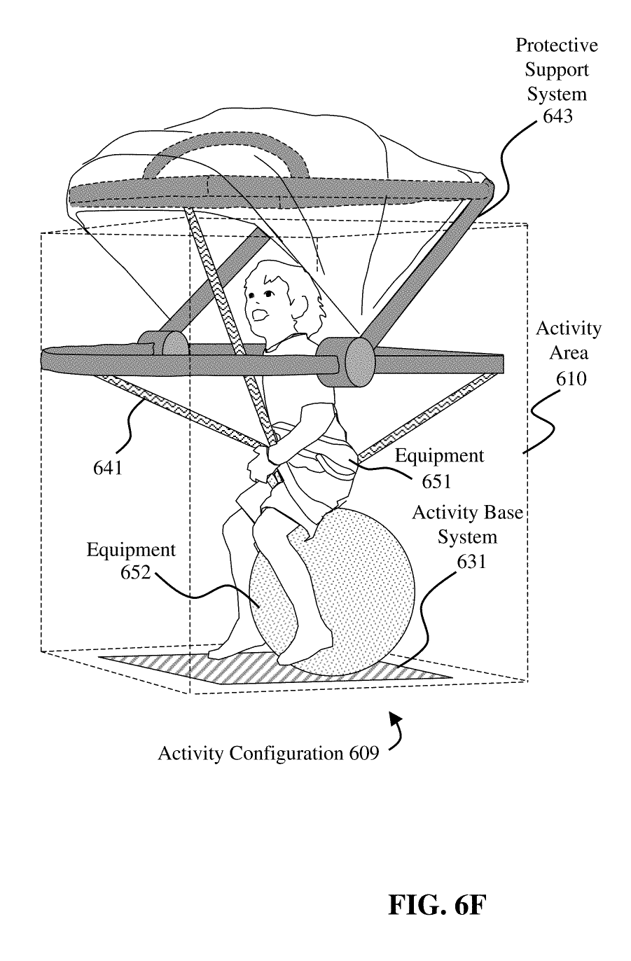

FIG. 6A illustrates another alternative embodiment of an activity configuration 605 comprised of an activity base system 630, equipment 650 and 651, and a protective support system 641 for a bouncing activity in an activity area 610 for an active stroller entertainment system. Embodiments of activity configuration 605 may comprise a protective support system 641 including nylon or another type of strapping, or bouncy elastic bungee cords, or some combination of both; and equipment 651 including e.g. a child's climbing harness. In some embodiments, portions of activity configuration 605 may be detached from the stroller chassis and still provide apparatus and/or equipment 650 to facilitate the bouncing activity outside the stroller. It will be appreciated that in some embodiments the activity base system 630 may also comprise a portion of the detachable apparatus and/or equipment 650 to facilitate bouncing activity outside the stroller. It will also be appreciated that in some embodiments protective support system 641 and/or equipment 651 may also be detached from the stroller chassis to facilitate a physical activity outside the stroller, e.g. a climbing activity such as rock climbing, tree climbing, or rope climbing.

In similarity with other bouncing activities, activity base system 630 may comprise a bouncy surface, e.g. such as rubber, inflatable, or trampoline; or alternatively may comprise a firm surface, e.g. such as a formed foam or plastic floor; and wherein either embodiments may comprise surfaces with enhanced traction to prevent a child from slipping, and/or easily cleanable surfaces or washable fabrics, e.g. to provide for easier clean ups.

FIG. 6B illustrates another alternative embodiment of stroller chassis 620 coupled with activity area 610 comprising activity base system 630 and a protective support system 641 for a bouncing activity in active stroller entertainment system 600.

FIG. 6C illustrates one embodiment of a stroller chassis 621 coupled with a protective support system 640 in an activity area 610 of an active stroller entertainment system 601. In some embodiments of active stroller entertainment system 601, stroller chassis 621 may have a foldable structure. As shown in active stroller entertainment system 601, some embodiments of a protective support system 640 may optionally provide additional protective support elements inside or underneath a sun shade canopy, especially in the case of a taller child and/or in combination with a standing physical activity.

FIG. 6D illustrates one alternative embodiment of a stroller chassis 622 coupled with a protective support system 642 in an activity area 610 of an active stroller entertainment system 602. As shown in active stroller entertainment system 602, some embodiments of a protective support system 642 may provide additional stabilizing elements coupled with the stroller chassis 622, and may optionally provide additional protective support elements inside or underneath a sun shade canopy, especially in the case of a taller child and/or in combination with a standing physical activity.

FIG. 6E illustrates an alternative embodiment of an activity configuration 607 comprised of an activity base system 630, equipment 650 and 651, operatively coupled with protective support system 641 and 643 for a bouncing activity in an activity area 610 for an active stroller entertainment system. Embodiments of protective support system 643 may optionally provide additional protective support elements inside or underneath a sun shade canopy, especially in the case of a taller child and/or in combination with a standing physical activity. In some embodiments, portions of activity configuration 607 may be detached from the stroller chassis to provide apparatus and/or equipment 650 to facilitate a bouncing activity outside the stroller.

FIG. 6F illustrates another alternative embodiment of an activity configuration 609 comprised of an activity base system 631, equipment 651 and 652, operatively coupled with protective support system 641 and 643 for a bouncing activity in an activity area 610 for an active stroller entertainment system. Embodiments of protective support system 640 may optionally provide additional protective support elements inside or underneath a sun shade canopy, especially in the case of a taller child and/or in combination with a standing physical activity. In some embodiments, portions of activity configuration 609 may be detached from the stroller chassis to provide apparatus and/or equipment 652 or 651 to facilitate a bouncing activity, or another activity respectively, outside the stroller.

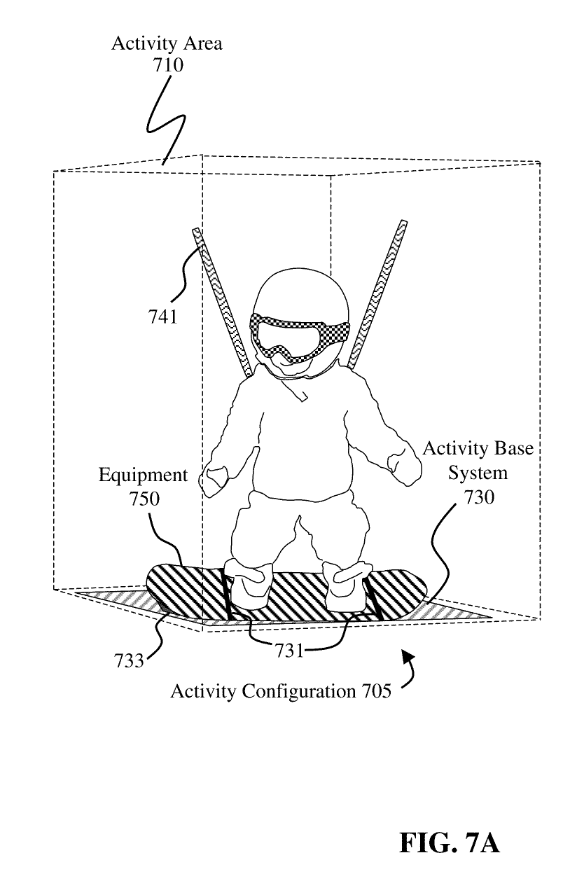

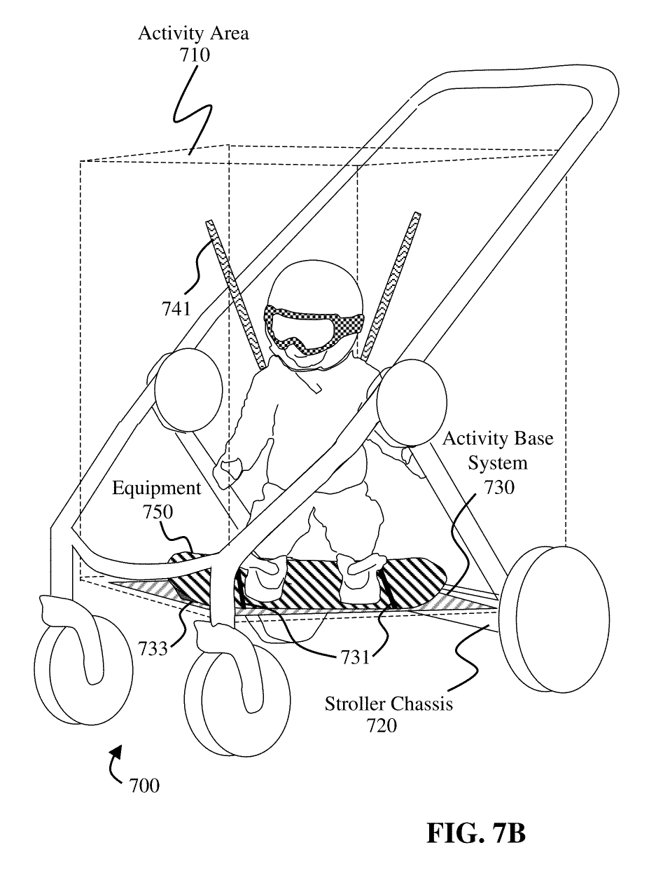

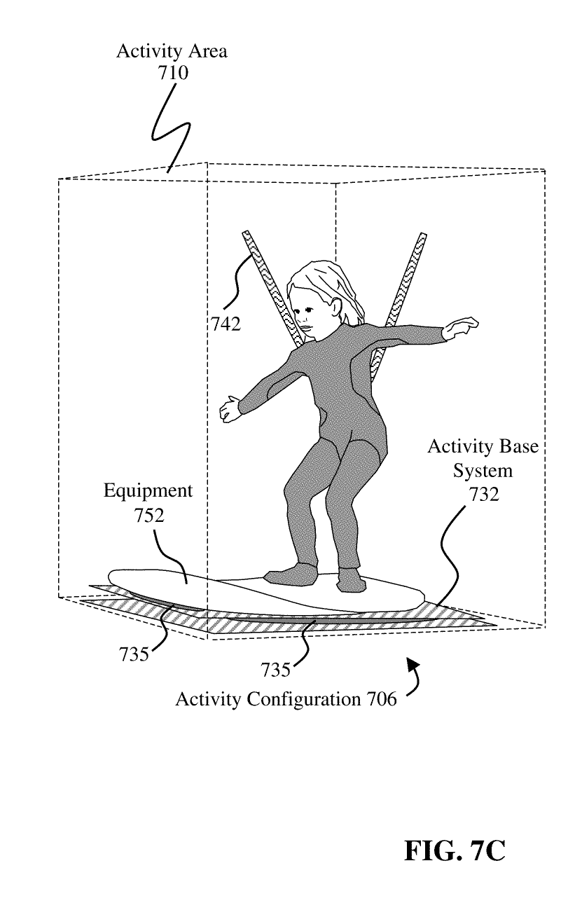

FIG. 7A illustrates another alternative embodiment of an activity configuration 705 comprised of an activity base system 730 and a protective support system 741 for a balancing activity in an activity area 710 for an active stroller entertainment system. Embodiments of activity configuration 705 may comprise a protective support system 741 including nylon or another type of strapping, or bungee cords, or some combination of both; and equipment 750 including e.g. a child's snow board, boots and bindings. In some embodiments, portions of activity configuration 705 may be detached from the stroller chassis and still provide apparatus and/or equipment 750 to facilitate a balancing activity outside the stroller, e.g. snow boarding, or it may just as well be skateboarding without the boots and bindings. In some embodiments of activity configuration 705, activity base system 730 may comprise one or more tie downs 731, e.g. such as loop-and-hook fasteners, straps, hooks and/or anchors to secure a board, bindings and/or wheels to the activity base system 730; and one or more equipment mounts 733, e.g. such as a swivelable and/or partly rockable platform to support the bottom surface of the underneath side of a snow board or a skateboard; and may also comprise surfaces with enhanced traction to prevent a child from slipping, and/or easily cleanable surfaces, e.g. to provide for easier clean ups.

It will be appreciated that introducing a child to a sport, e.g. such as snow boarding or skateboarding, may involve potential risks of injury due, in part, to the child's inexperience and to a lack of practice in exercising the skills required by the sport. It will also be appreciated that may necessary to transport the child along with any equipment required for the sport, e.g. through trams and gondolas to the slopes where the sport may then be pursued. The active stroller entertainment system provides for transporting the child along with any equipment required, in a protective environment where the child may play in anticipation, while safely developing and improving skills, e.g. such as strength, balance, coordination, etc., which will be necessary to the child's successful participation in the sport.

FIG. 7B illustrates another alternative embodiment of a stroller chassis 720 coupled with activity area 710 comprising activity base system 730 for a balancing activity in active stroller entertainment system 700.

FIG. 7C illustrates another alternative embodiment of an activity configuration 706 comprised of an activity base system 732 and a protective support system 742 for a balancing activity in an activity area 710 for an active stroller entertainment system. Embodiments of activity configuration 706 may comprise a protective support system 742 including nylon or another type of strapping, or bungee cords, or some combination of both; and equipment 752 including e.g. a child's surfboard, or boogie board. In some embodiments, portions of activity configuration 706 may be detached from the stroller chassis and still provide apparatus and/or equipment 752 to facilitate a balancing activity outside the stroller, e.g. surfing, boogie boarding, or it may just as well be skateboarding. In some embodiments of activity configuration 706, activity base system 732 may comprise one or more tie downs, e.g. such as loop-and-hook fasteners, straps, hooks and/or anchors to secure a board, to the activity base system 730; and one or more equipment mounts 735, e.g. such as a swivelable and/or partly rockable platform to support the bottom surface of the underneath side of a surfboard or a boogie board; and may also comprise surfaces with enhanced traction to prevent a child from slipping, and/or easily cleanable surfaces, e.g. to provide for easier clean ups.

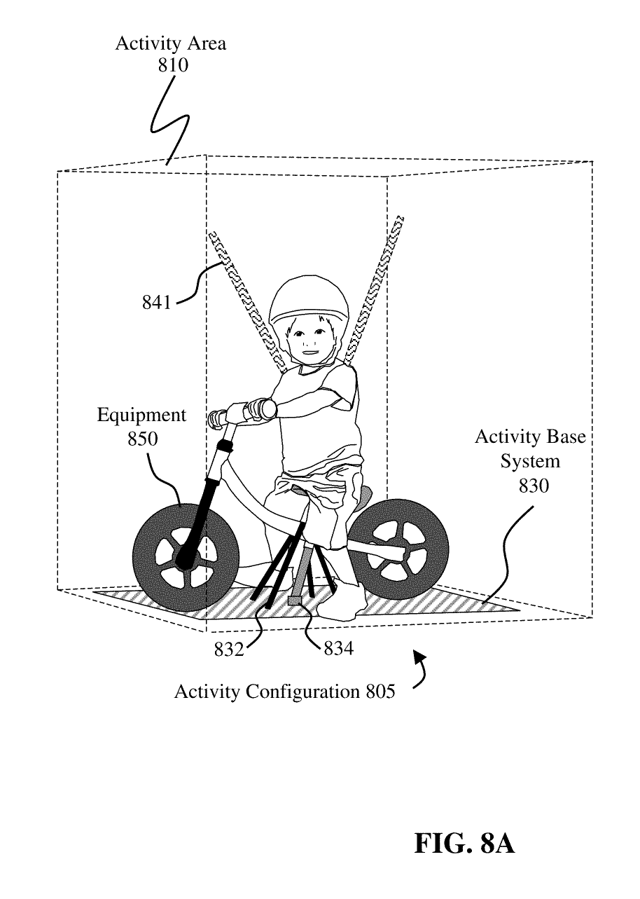

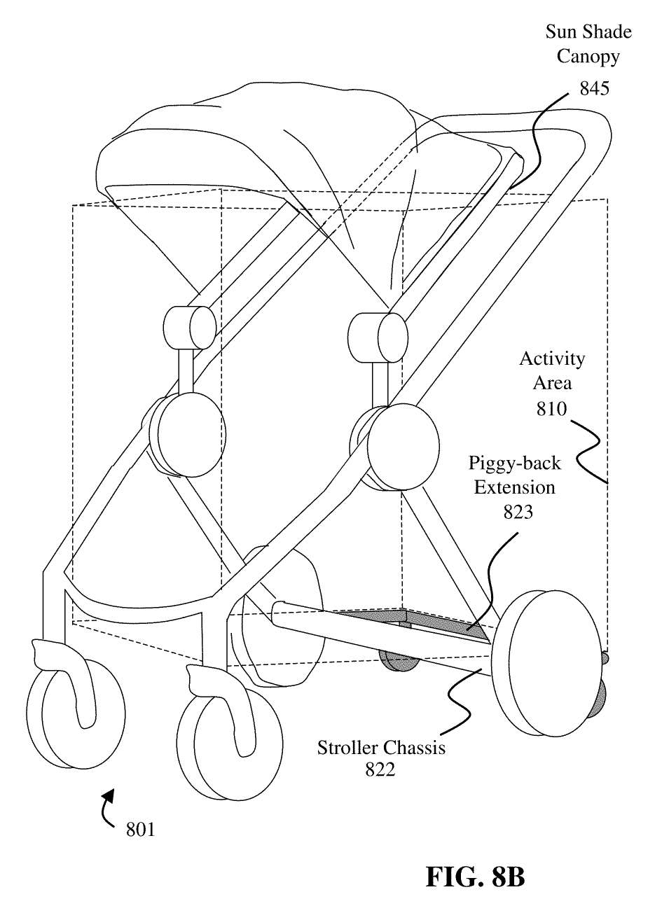

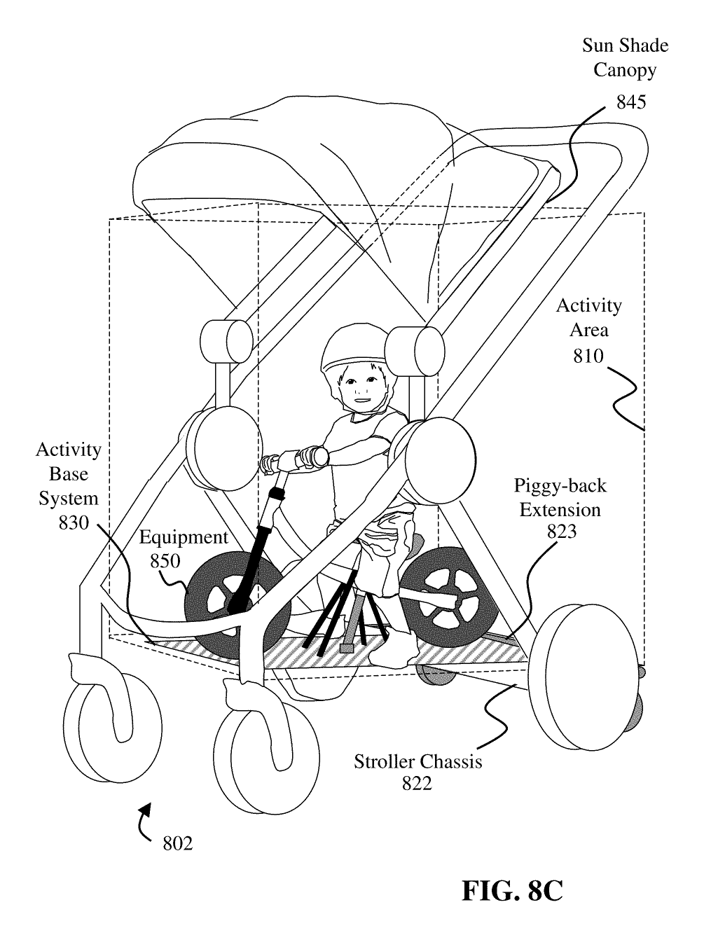

FIG. 8A illustrates another alternative embodiment of an activity configuration 805 comprised of an activity base system 830 and an optional protective support system 841 for a balancing activity in an activity area 810 for an active stroller entertainment system. Embodiments of activity configuration 805 may optionally comprise a protective support system 841 including, e.g. nylon or another type of strapping, or bungee cords, or some combination of both; and equipment 850 including e.g. a child's training bicycle or strider. In some embodiments, portions of activity configuration 805 may be detached from the stroller chassis to provide apparatus and/or equipment 850 to facilitate an activity outside the stroller, e.g. striding or run-ride bicycling. In some embodiments of activity configuration 805, activity base system 830 may comprise one or more tie downs 832, e.g. such as straps, hooks and/or anchors to secure a frame, fork and/or wheels to the activity base system 830 surface; and one or more equipment mounts 834, e.g. such as a swivelable and/or partly flexible pipe with a quick-clamp to receive a saddle support bar; and may also comprise surfaces with enhanced traction to prevent a child from slipping, and/or easily cleanable surfaces, e.g. to provide for easier clean ups.

FIG. 8B illustrates one alternative embodiment of a stroller chassis 822 extendedly coupled with an activity area 810 in an active stroller entertainment system 801 to facilitate a physical activity when the child is inside the stroller. In some embodiments of active stroller entertainment system 801, stroller chassis 822 may be extended by coupling to a piggy-back extension 823 to increase the activity area 810. In some embodiments of active stroller entertainment system 801, stroller chassis 822 may have a foldable structure. Some embodiments of active stroller entertainment system 801 may also comprise a sun shade canopy 845, which may optionally include protective support elements (not shown) inside or underneath the sun shade canopy 845.

FIG. 8C illustrates an alternative embodiment of an extended stroller chassis 822 coupled with an activity area 810 comprising an activity base system 830 for a balancing activity in an active stroller entertainment system 802. In some embodiments of active stroller entertainment system 802, stroller chassis 822 may be extended by coupling to a piggy-back extension 823, increasing the length of activity area 810, e.g. to approximately three feet (or one meter) to accommodate activity base system 830 and equipment 850 including e.g. a child's training bicycle or strider. Some embodiments of active stroller entertainment system 801 may also comprise a sun shade canopy 845, which may optionally include protective support elements (not shown) inside or underneath the sun shade canopy 845 and which may optionally be coupled with protective support system 841 (not shown).

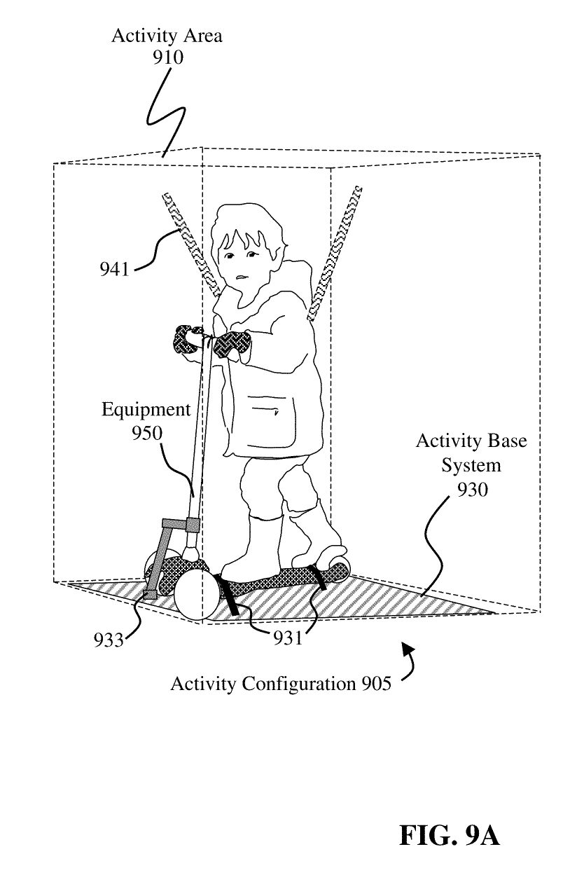

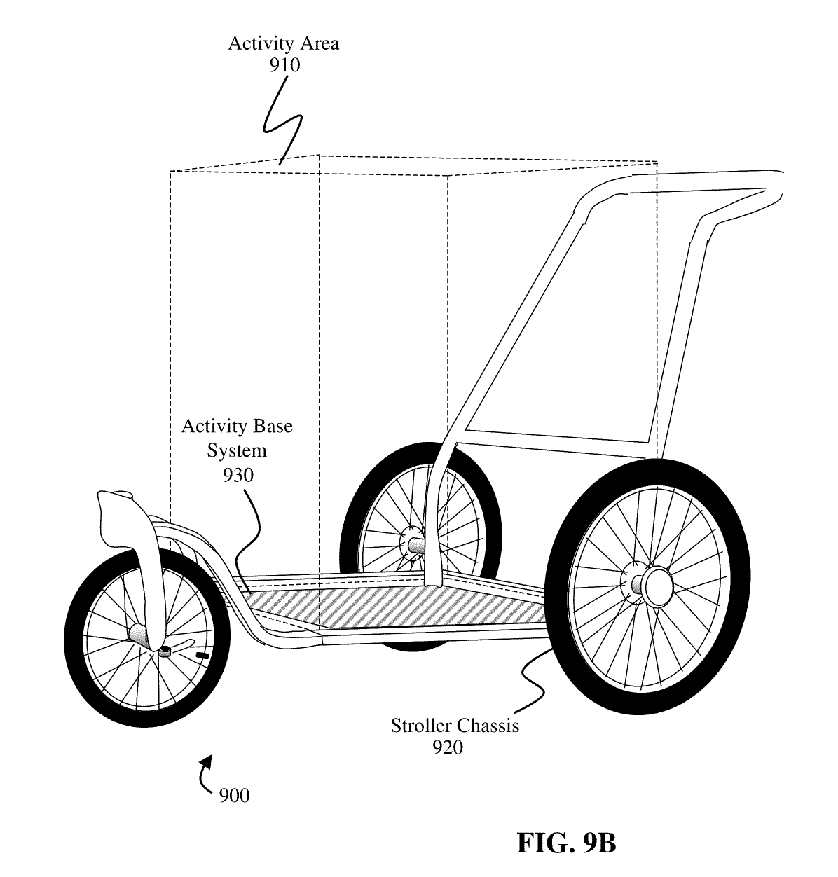

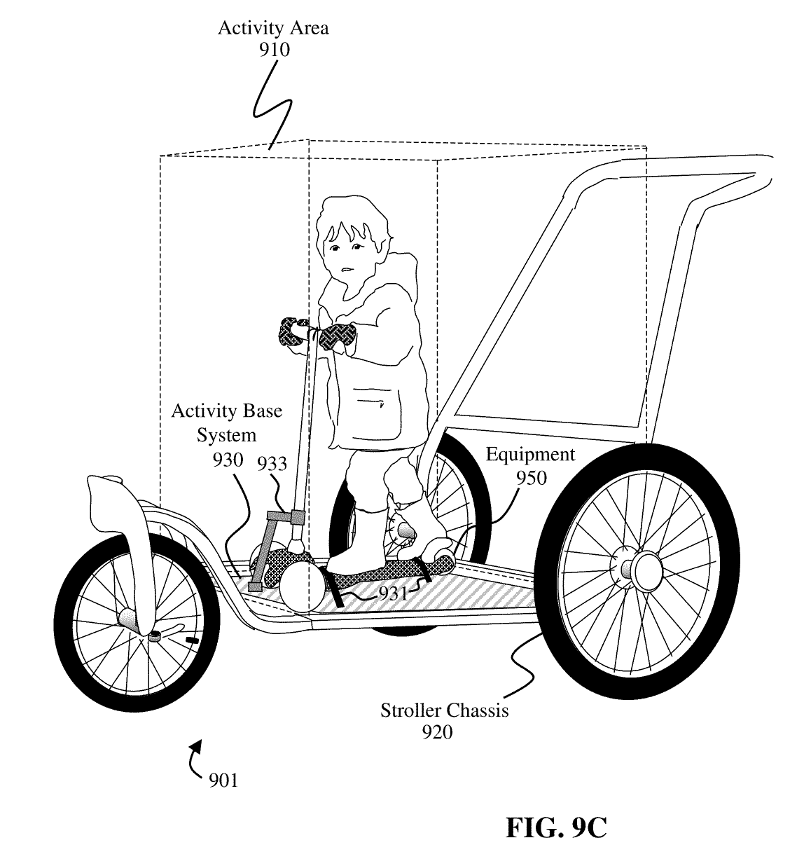

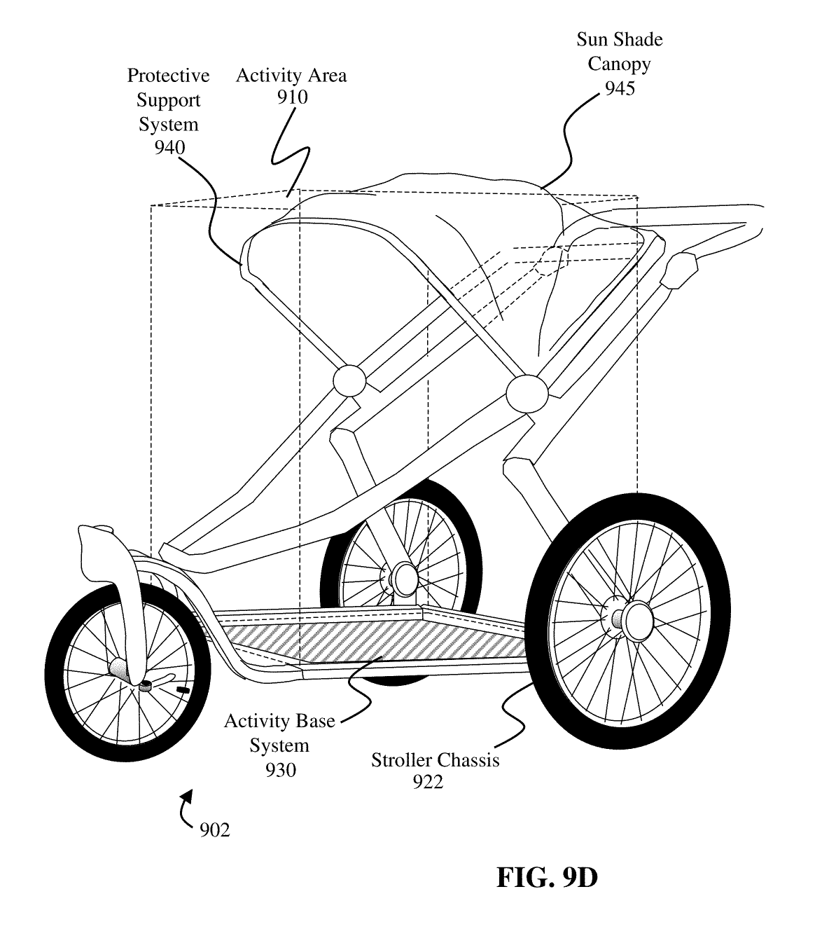

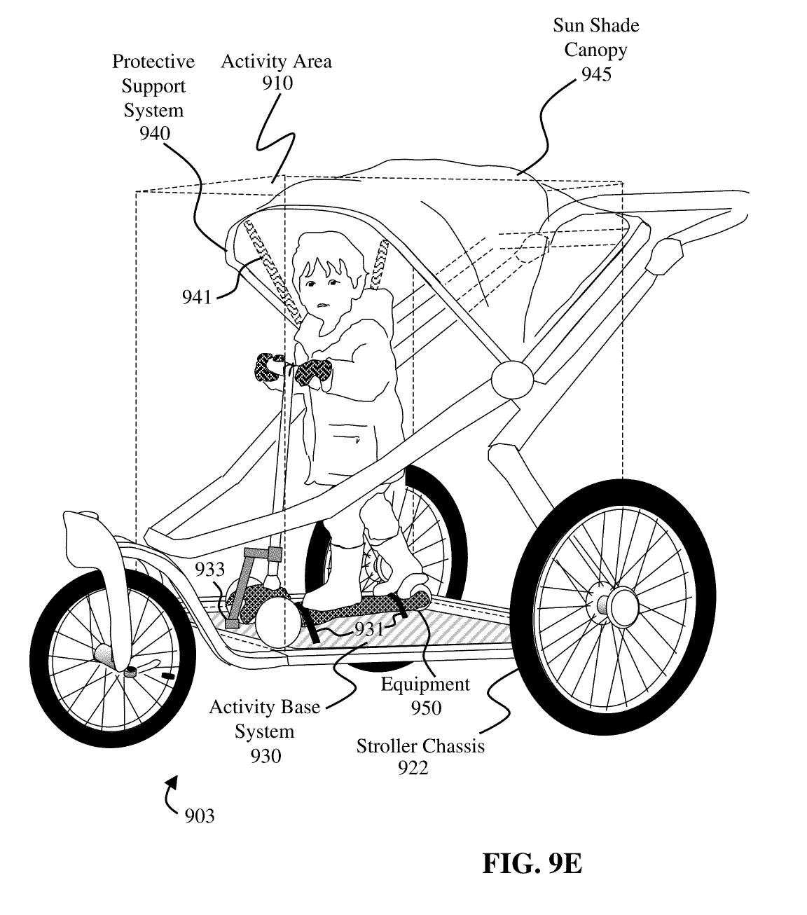

FIG. 9A illustrates another alternative embodiment of an activity configuration 905 comprised of an activity base system 930 and an optional protective support system 941 for a balancing activity in an activity area 910 for an active stroller entertainment system. Embodiments of activity configuration 905 optionally comprise protective support system 941 including, e.g. nylon or another type of strapping, or bungee cords, or some combination of both; and equipment 950 including e.g. a child's scooter or skateboard. In some embodiments, portions of activity configuration 905 may be detached from the stroller chassis to provide apparatus and/or equipment 950 to facilitate an activity outside the stroller, e.g. scooter or skateboard riding. In some embodiments of activity configuration 905, activity base system 930 may comprise one or more tie downs 931, e.g. such as straps, hooks and/or anchors to secure a footboard, skateboard and/or wheels to the activity base system 930 surface; and one or more equipment mounts 933, e.g. such as a swivelable and/or partly flexible bracket with a clamp to receive a handlebar support rod; and may also comprise surfaces with enhanced traction to prevent a child from slipping, and/or easily cleanable surfaces, e.g. to provide for easier clean ups.

FIG. 9B illustrates an alternative embodiment of a stroller chassis 920 coupled with an activity base system 930 in an activity area 910 of an active stroller entertainment system 900. In some embodiments of active stroller entertainment system 900, activity area 910 may be suitable to accommodate an activity base system 930, e.g. of approximately 24 to 30 inches in length and approximately 12 to 16 inches in width. In some embodiments of active stroller entertainment system 900, stroller chassis 920 may be designed for use as a jogging stroller.

FIG. 9C illustrates an alternative embodiment of a stroller chassis 920 coupled with an activity area 910 comprising an activity base system 930 for a balancing activity in an active stroller entertainment system 901.

FIG. 9D illustrates another alternative embodiment of a stroller chassis 922 coupled with an activity base system 930 in an activity area 910 of an active stroller entertainment system 902. In some embodiments of active stroller entertainment system 902, stroller chassis 922 may have a foldable structure. Some embodiments of active stroller entertainment system 902 may also comprise a sun shade canopy 945, which may include structural support elements of a protective support system 940 inside or underneath the sun shade canopy 945. In some embodiments of active stroller entertainment system 902, stroller chassis 922 may also be designed for use as a jogging stroller.

FIG. 9E illustrates an alternative embodiment of a stroller chassis 922 coupled with an activity area 910 comprising an activity base system 930 for a balancing activity in an active stroller entertainment system 903. Some embodiments of active stroller entertainment system 903 may also comprise a sun shade canopy 945, which may include structural support elements of a protective support system 940 inside or underneath the sun shade canopy 945 and which may optionally be coupled with protective support system 941.

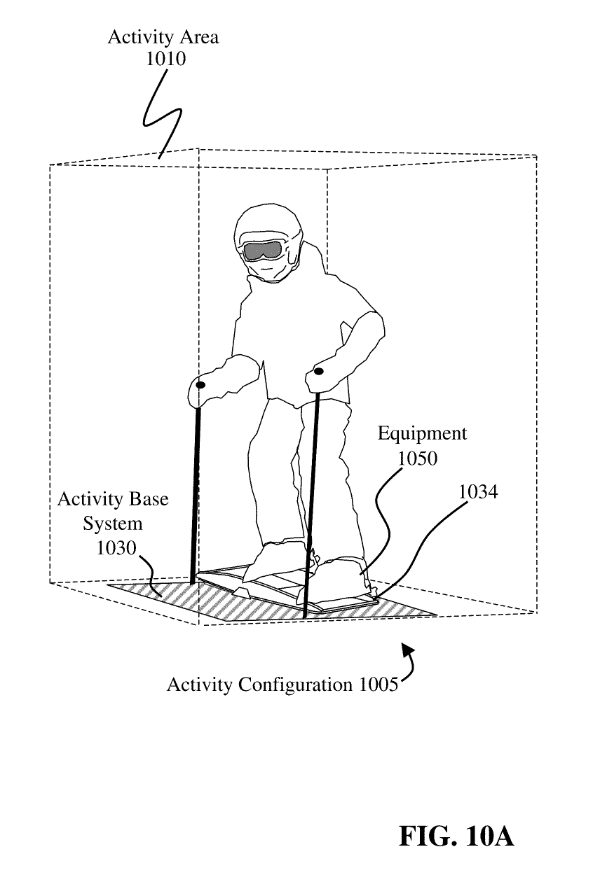

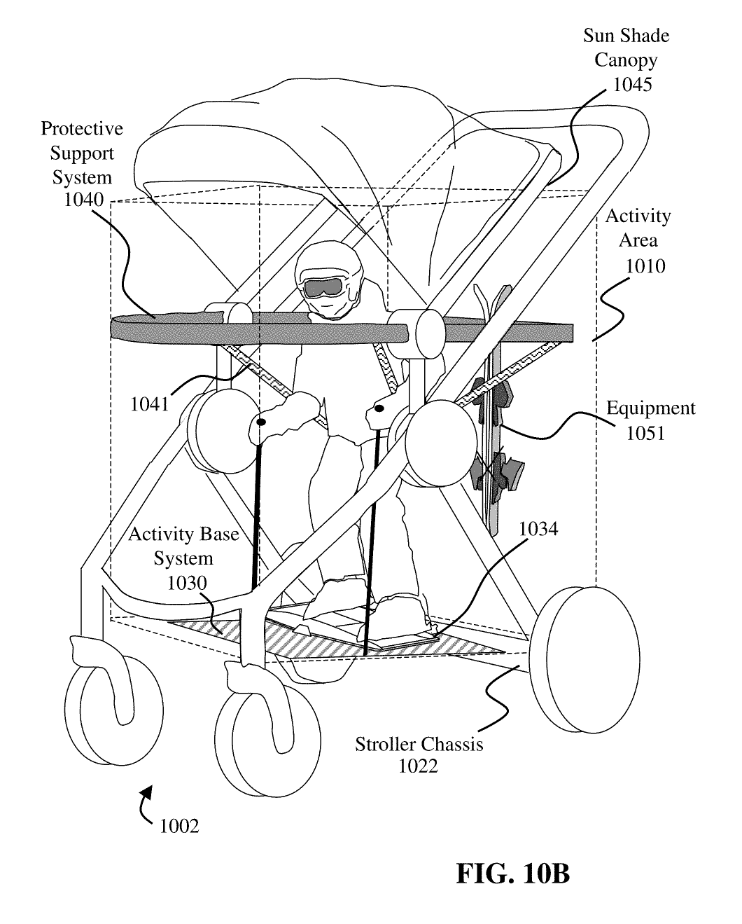

FIG. 10A illustrates another alternative embodiment of an activity configuration 1005 comprised of an activity base system 1030 for a balancing activity in an activity area 1010 for an active stroller entertainment system. Embodiments of activity configuration 1005 optionally comprise a protective support system (not shown) including, e.g. nylon or another type of strapping, or bungee cords, or some combination of both. In some embodiments of activity configuration 1005, activity base system 1030 may comprise a activity simulator 1034, e.g. such as a rockable skiing simulator; and may also comprise equipment 1050, e.g. such as ski boots and/or ski polls.

FIG. 10B illustrates another alternative embodiment of a stroller chassis 1022 coupled with an activity area 1010 comprising an activity base system 1030 and operatively coupled with a protective support system 1040 in an active stroller entertainment system 1002. Embodiments of active stroller entertainment system 1002 comprises protective support system 1040 which may optionally be coupled with protective support system 1041 including, e.g. nylon or another type of strapping, or bungee cords, or some combination of both, to operatively provide support to a child and protection from physical injury within the activity area 1010 during the physical balancing activity. Some embodiments of active stroller entertainment system 1002 may also comprise additional storage for equipment 1051, e.g. such as skis and bindings, and may also comprise a sun shade canopy 1045, which may optionally include protective support elements (not shown) inside or underneath the sun shade canopy 1045 and which may optionally be coupled with the protective support system(s) 1040 and 1041.

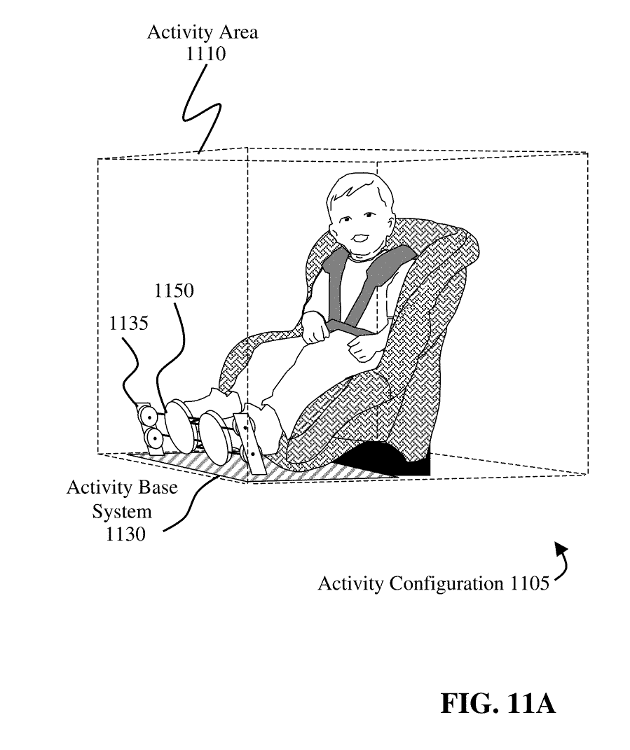

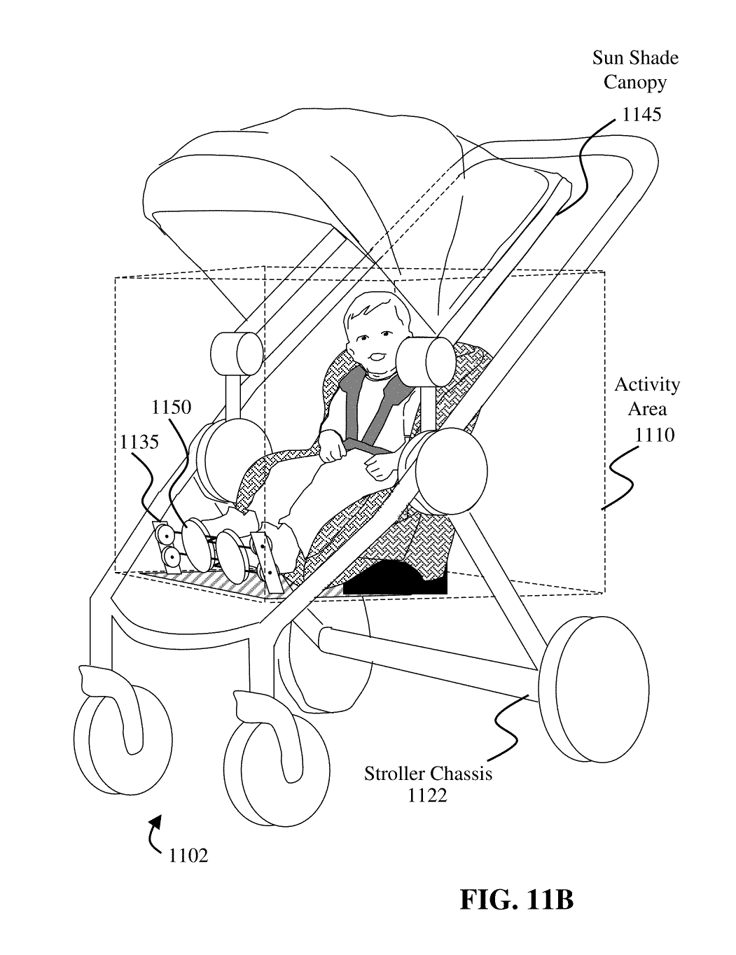

FIG. 11A illustrates another alternative embodiment of an activity configuration 1105 comprised of an activity base system 1130 for a pedaling activity in an activity area 1110 for an active stroller entertainment system. In some embodiments of activity configuration 1105, activity base system 1130 may comprise a activity simulator 1135, e.g. such as a pedaling simulator; and/or the activity simulator 1135 may comprise equipment 1150, e.g. such as a pedal pushing wheel walker.

FIG. 11B illustrates another alternative embodiment of a stroller chassis 1122 coupled with an activity area 1110 comprising an activity base system 1130 for a pedaling activity in an active stroller entertainment system. Some embodiments of active stroller entertainment system 1102 may also comprise a sun shade canopy 1145, and activity base system 1130 may comprise a activity simulator 1135—the activity simulator 1135 comprising equipment 1150.

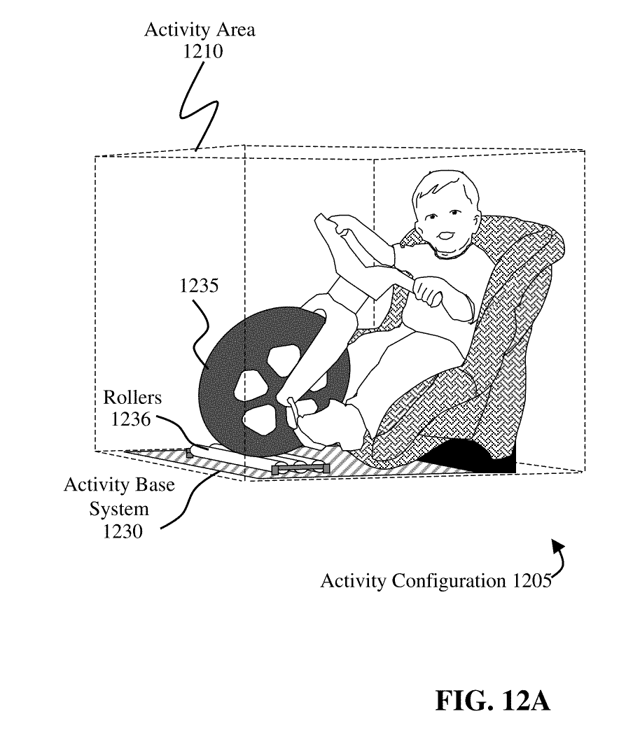

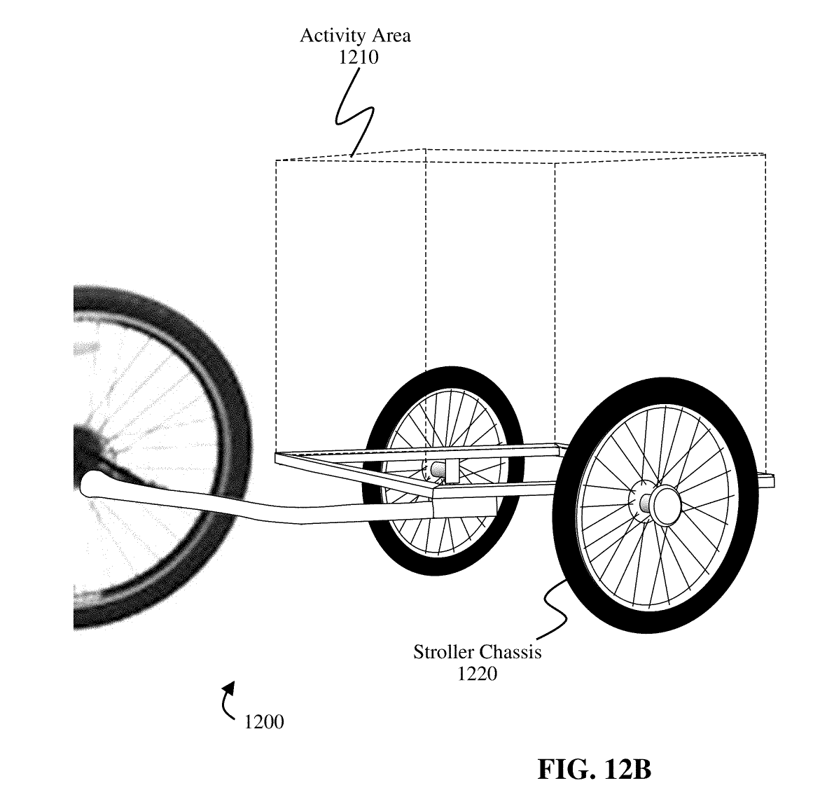

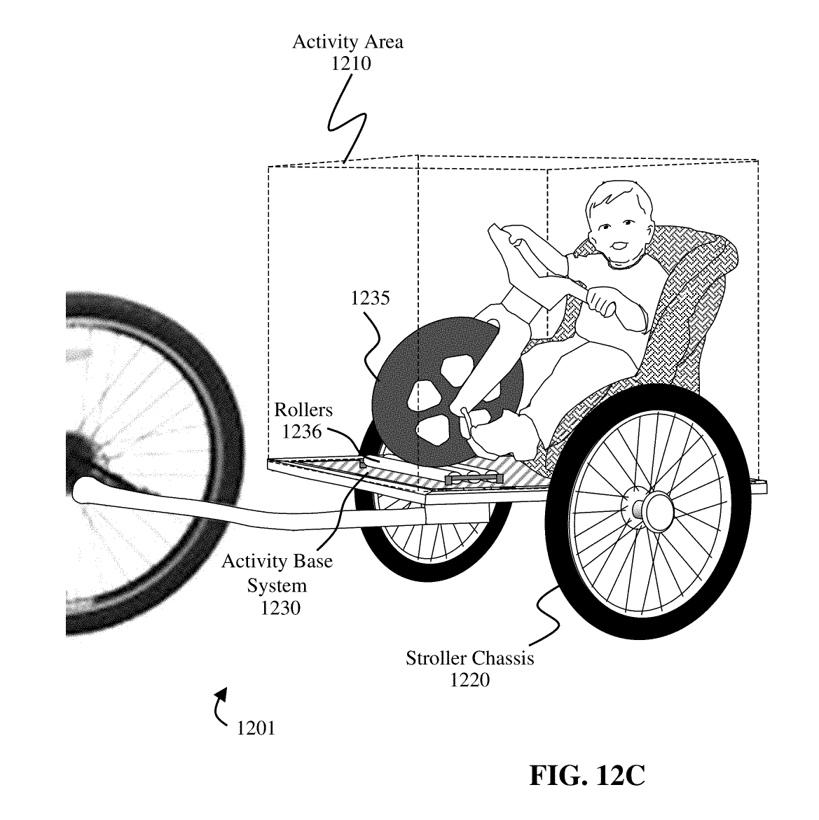

FIG. 12A illustrates another alternative embodiment of an activity configuration 1205 comprised of an activity base system 1230 for a pedaling activity in an activity area 1210 for an active stroller entertainment system. In some embodiments of activity configuration 1205, activity base system 1230 may comprise a activity simulator 1235 and 1236, e.g. such as a big wheel pedaling simulator 1235 and/or rollers 1236.

FIG. 12B illustrates an alternative embodiment of a stroller chassis 1220 coupled with an activity area 1210 in an active stroller entertainment system 1200. In some embodiments of active stroller entertainment system 1200, stroller chassis 1220 may be used alternatively as a jogging stroller, or coupled to, and pulled behind a bicycle as shown.

FIG. 12C illustrates an alternative embodiment of a stroller chassis 1220 coupled with an activity area 1210 comprising an activity base system 1230 for a pedaling activity in an active stroller entertainment system 1201. In some embodiments of active stroller entertainment system 1201, activity base system 1130 may comprise an activity simulator 1235 and 1236, e.g. such as a big wheel pedaling simulator 1235 and/or rollers 1236.

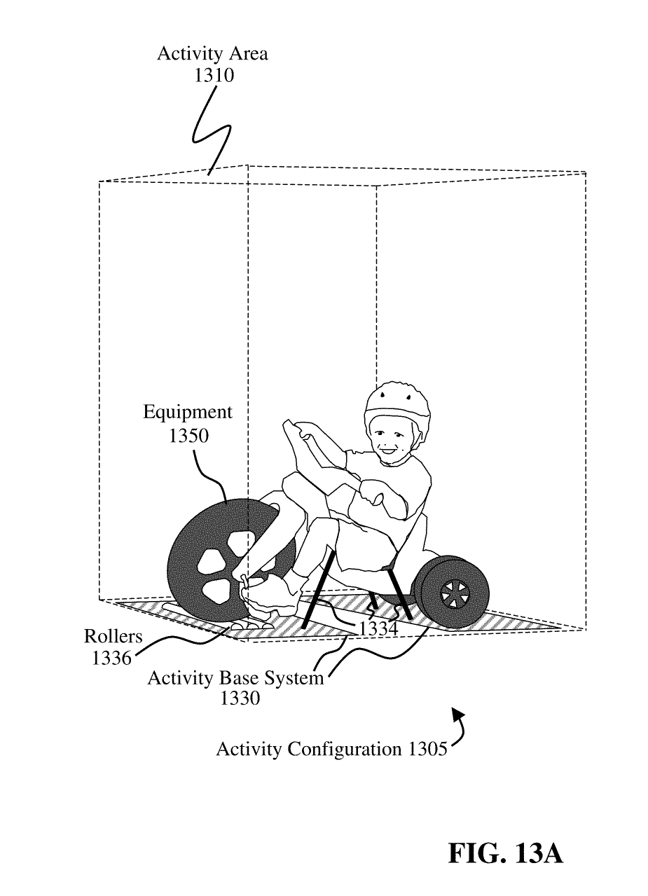

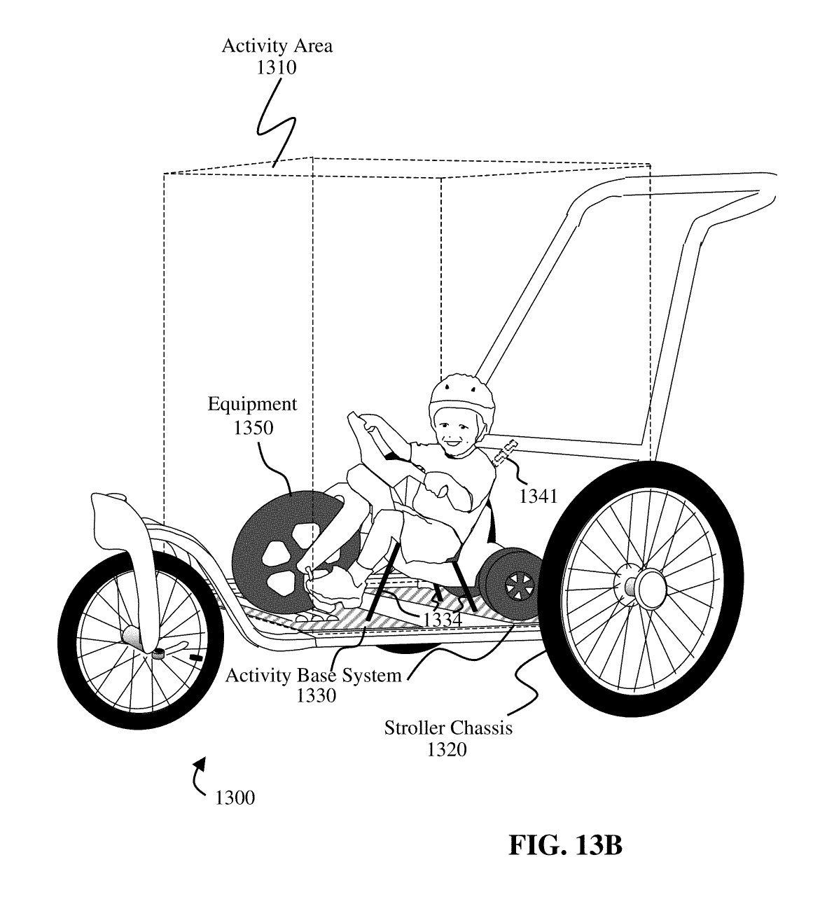

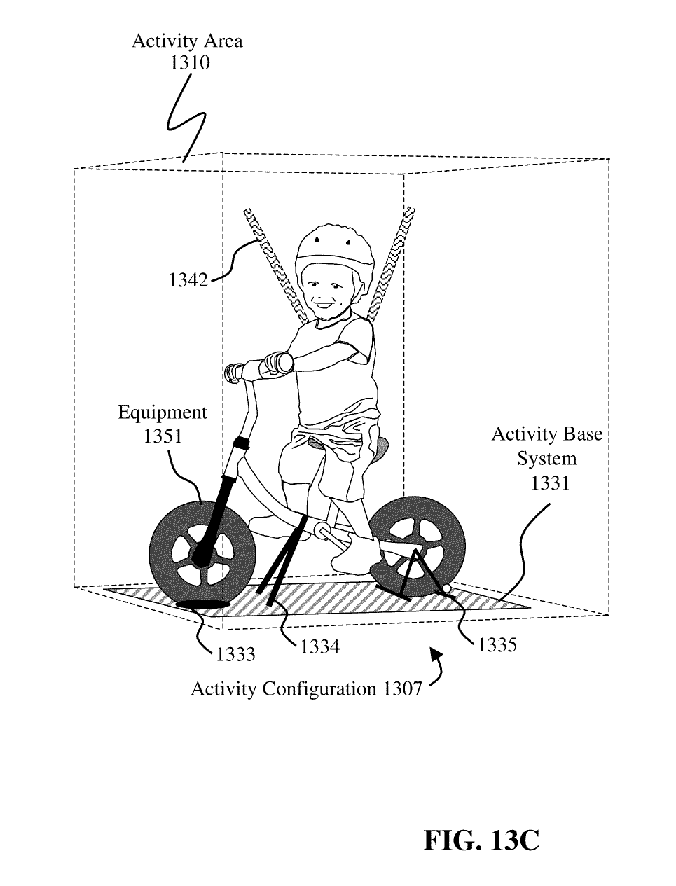

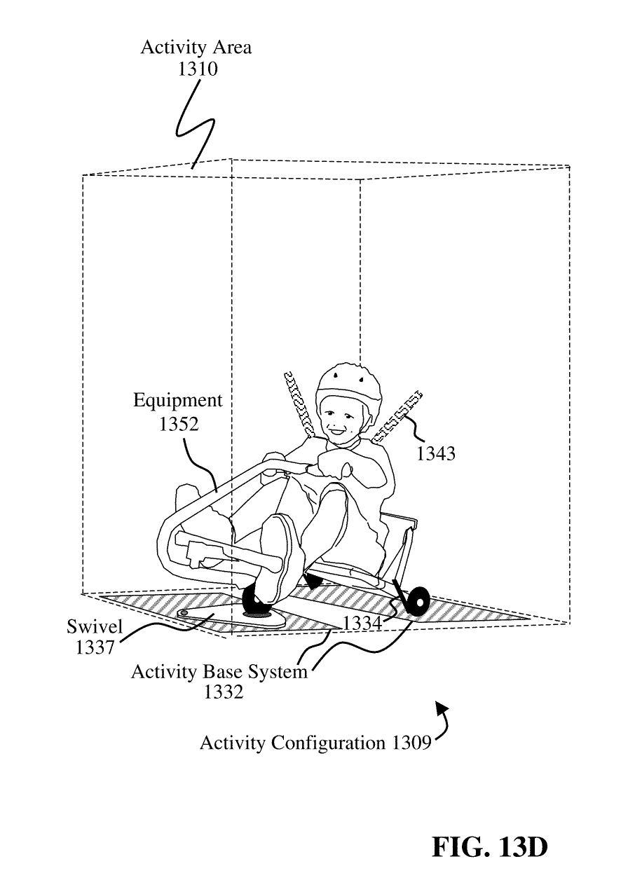

FIG. 13A illustrates another alternative embodiment of an activity configuration 1305 comprised of an activity base system 1330 for a pedaling activity in an activity area 1310 for an active stroller entertainment system. Embodiments of activity configuration 1305 may comprise equipment 1350 including e.g. a big wheel, or child's sport tricycle. In some embodiments, portions of activity configuration 1305 may be detached from the stroller chassis and still provide apparatus and/or equipment 1350 to facilitate a pedaling activity outside the stroller, e.g. tricycle riding. In some embodiments of activity configuration 1305, activity base system 1330 may comprise one or more tie downs 1334, e.g. such as loop-and-hook fasteners, straps, hooks and/or anchors to secure equipment 1350, to the activity base system 1330; and one or more equipment mounts 1336, e.g. such as rollers 1336; and may also comprise surfaces with enhanced traction to prevent a child from slipping, and/or easily cleanable surfaces, e.g. to provide for easier clean ups.

FIG. 13B illustrates another alternative embodiment of a stroller chassis 1320 coupled with an activity area 1310 comprising an activity base system 1330 for a pedaling activity in an active stroller entertainment system 1300. Embodiments of stroller chassis 1320 may include e.g. a three-wheeled jogging stroller. Some embodiments of active stroller entertainment system 1300 may also comprise protective support system 1341 including, e.g. nylon or another type of strapping, or bungee cords, or some combination of both, to operatively provide support to a child and protection from physical injury within the activity area 1310 during the physical pedaling activity. Activity base system 1330 may comprise one or more tie downs 1334, e.g. such as loop-and-hook fasteners, straps, hooks and/or anchors to secure equipment 1350 including e.g. a big wheel, or child's sport tricycle, to the activity base system 1330; and one or more equipment mounts 1336, e.g. such as rollers 1336.

FIG. 13C illustrates another alternative embodiment of an activity configuration 1307 comprised of an activity base system 1331 for a pedaling activity in an activity area 1310 for an active stroller entertainment system. Embodiments of activity configuration 1307 may comprise equipment 1351 including e.g. a child's bicycle, pedal cycle bike, or glide bike; and may also comprise protective support system 1342 including, e.g. nylon or another type of strapping, or bungee cords, or some combination of both, to operatively provide support to a child and protection from physical injury within the activity area 1310 during the physical pedaling activity. In some embodiments, portions of activity configuration 1307 may be detached from the stroller chassis and still provide apparatus and/or equipment 1351 to facilitate a pedaling activity outside the stroller, e.g. bicycle riding. In some embodiments of activity configuration 1307, activity base system 1331 may comprise one or more tie downs 1334, e.g. such as loop-and-hook fasteners, straps, hooks and/or anchors to secure equipment 1351, to the activity base system 1331; and one or more equipment mounts 1333 and 1335, e.g. such as front-wheel mount 1333 or an exercise stand wheel-block trainer 1335; and may also comprise surfaces with enhanced traction to prevent a child from slipping, and/or easily cleanable surfaces, e.g. to provide for easier clean ups.

FIG. 13D illustrates another alternative embodiment of an activity configuration 1309 comprised of an activity base system 1332 for a drifting activity in an activity area 1310 for an active stroller entertainment system. Embodiments of activity configuration 1309 may comprise equipment 1352 including e.g. a child's pedal drifter, drifter tricycle, or an EzyRoller drifter; and may also comprise protective support system 1343 including, e.g. nylon or another type of strapping, or bungee cords, or some combination of both, to operatively provide support to a child and protection from physical injury within the activity area 1310 during the physical drifting activity. In some embodiments, portions of activity configuration 1309 may be detached from the stroller chassis and still provide apparatus and/or equipment 1352 to facilitate an activity outside the stroller, e.g. drifting. In some embodiments of activity configuration 1309, activity base system 1332 may comprise one or more tie downs 1334, e.g. such as loop-and-hook fasteners, straps, hooks and/or anchors to secure equipment 1352, to the activity base system 1332; and one or more equipment mounts 1337, e.g. such as the front-wheel swivel mount 1337.

It will be appreciated that as a child grows and want to participate more in physical activity outside the stroller, e.g. such as bouncing, bicycle riding, drifting, sport tricycle riding, snow boarding, skiing, surfing, boogie boarding or skateboarding; these activities may involve potential risks of injury due, in part, to the child's inexperience and to a lack of practice in exercising the skills required by the sport. It will also be appreciated that it may be necessary to transport the child along with any equipment required for a physical activity outside the stroller, e.g. in city streets and through traffic signals, on trams and gondolas to ski slopes, or to playgrounds and/or special parks where the physical activity may then be pursued. The active stroller entertainment system provides for transporting the child along with any equipment required, in a protective environment where the child may play in anticipation, while safely developing and improving skills, e.g. such as physical strength, balance, coordination, etc., which will be necessary to the child's successful participation in the physical activity outside the stroller.

The above description is intended to illustrate preferred embodiments of the present invention. From the discussion above it should also be apparent that especially in such an area of technology, where growth is fast and further advancements are not easily foreseen, the invention may be modified in arrangement and detail by those skilled in the art without departing from the principles of the present invention within the scope of the accompanying claims and their equivalents.

What is claimed is:

1. A stroller apparatus comprising:
a stroller chassis;
an activity base system coupled with the stroller chassis and configured to facilitate a physical activity for a child when the child is inside the stroller; and
a protective support system coupled with the stroller chassis, wherein the protective support system is operatively coupled with the activity base system and configured to support the child during the physical activity when the child is inside the stroller.

2. The apparatus of claim 1, wherein said activity base system and said protective support system are coupled with the stroller chassis, at least in part to form an activity area, inside the stroller, sufficient to facilitate said physical activity when the child is inside the stroller, while operatively providing support to the child and protection from physical injury within said activity area during the physical activity; and
said activity area being configured to facilitate said physical activity for the child when the child is inside the stroller, by comprising equipment particularly related to said physical activity, with which the child can actively interact when the child is inside the activity area, and configured to improve the child's physical activity skills.

3. The apparatus of claim 2, wherein said physical activity comprises a bouncing activity.

4. The apparatus of claim 2, wherein said physical activity comprises a balancing activity.

5. The apparatus of claim 2, wherein said physical activity comprises a pedaling activity.

6. The apparatus of claim 5, wherein said physical activity comprises a drifting activity.

7. An active stroller entertainment system comprising:
an activity base system, detachably attachable with a stroller chassis, and configured to facilitate a physical activity for a child when the child is inside the stroller; and
a protective support system, detachably attachable with the stroller chassis, and configured to operatively couple with the activity base system to support the child during the physical activity.

8. The system of claim 7, wherein said activity base system and said protective support system are detachably attached with a first stroller chassis, at least in part to form an activity area, inside the stroller, sufficient to facilitate said physical activity when the child is inside the stroller while operatively providing support to the child and protection from physical injury within said activity area during the physical activity; and
said activity area being configured to facilitate said physical activity for the child when the child is inside the stroller, by comprising equipment particularly related to said physical activity, with which the child can actively interact when the child is inside the activity area, and configured to improve the child's physical activity skills.

9. The system of claim 8, wherein said physical activity comprises a bouncing activity.

10. The system of claim 9, wherein said activity area equipment comprises a trampoline.

11. The system of claim 8, wherein said physical activity comprises a balancing activity.

12. The system of claim 11, wherein said activity area equipment comprises a skateboard.

13. The system of claim 11, wherein said activity area equipment comprises a snow board.

14. The system of claim 11, wherein said activity area equipment comprises a surfboard or boogie board.

15. The system of claim 11, wherein said activity area equipment comprises a trainer bike.

16. The system of claim 11, wherein said activity area equipment comprises a scooter.

17. The system of claim 11, wherein said activity area equipment comprises a ski simulator.

18. The system of claim 8, wherein said physical activity comprises a pedaling activity.

19. The system of claim 18, wherein said activity area equipment comprises a tricycle.

20. An active stroller entertainment system comprising:
a stroller chassis;
an activity means, said activity means coupled with the stroller chassis, for facilitating a physical activity for a child when the child is inside the stroller; and
a support means, said support means coupled with the stroller chassis and operatively coupled with the activity means for supporting the child during the physical activity when the child is inside the stroller.

21. The system of claim 20, wherein said activity means and said support means are coupled with the stroller chassis, at least in part to form an activity area inside the stroller and sufficient to facilitate said physical activity when the child is inside the stroller, while operatively providing support to the child and protection from physical injury within said activity area during the physical activity; and
said activity area being configured to facilitate said physical activity for the child when the child is inside the stroller, by comprising equipment particularly related to said physical activity, with which the child can actively interact when the child is inside the activity area, and configured to improve the child's physical activity skills.
